(19) United States
(12) Patent Application Publication
(10) Pub. No.: US 2008/0201233 A1
(43) Pub. Date: Aug. 21, 2008

(54) METHOD AND SYSTEM FOR MANAGING REAL ESTATE TRANSACTIONS

(76) Inventors: Scott Schellinger, Santa Rosa, CA (US); Todd Trask, Santa Rosa, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/112,921

(22) Filed: Apr. 30, 2008

Related U.S. Application Data
(63) Continuation of application No. 10/603,569, filed on Jun. 25, 2003, now abandoned.
(60) Provisional application No. 60/391,869, filed on Jun. 25, 2002.

(51) Int. Cl. G06Q 20/00

(52) U.S. Cl. 705/24

(57) ABSTRACT

A system for managing real estate purchase transactions is provided. The system collects various types of information relating to real estate purchase transactions. The system then tracks various milestones under a real estate purchase contract and provides automated alerts to one or more users. The system further allows different users with varying functional roles to monitor their respective real estate purchase contracts.

### CROSS-REFERENCES TO RELATED APPLICATION(S)

This application is a continuation of co-pending U.S. patent application Ser. No. 10/603,569, filed Jun. 25, 2003, which in turn claims the benefit of priority under 35 U.S.C. §119 from U.S. Provisional Patent Application Ser. No. 60/391,869, entitled “METHOD AND SYSTEM FOR MANAGING REAL ESTATE TRANSACTIONS,” filed on Jun. 25, 2002, the disclosure of which is hereby incorporated by reference in its entirety for all purposes.

### BACKGROUND OF THE INVENTION

The present invention generally relates to real estate transactions. More specifically, the present invention relates to a method and system for managing real estate transactions and warranties in an automated manner.

As it currently exists, the process of managing and overseeing a real estate purchase transaction is quite paper- and labor-intensive. Conventional practice used in managing real estate purchase transactions involves manual monitoring of events for compliance before the real estate purchase transaction can be consummated. For example, after the purchase contract has been executed, the real estate agent still needs to continue to monitor certain events that are required under the contract. Typically, the monitoring of these events is done manually on an ad hoc basis. As a result, when a large number of contracts need to be monitored, the risk of missing or mismanaging a critical event under a contract is heightened. The consequence of such occurrence can be the termination of the real estate purchase contract.

Furthermore, parties to a purchase contract often seek to inquire information relating to the status of the contract as well as other purchase-related matters. Typically, the requested information is provided to the requesting party only upon manual examination of the contract and any related papers by the real estate agent. Consequently, this process is slow and time-consuming.

Hence, it would be desirable to provide a method and system that is capable of managing real estate transactions in an automated manner so as to reduce the likelihood of error and provide information in an expedited manner.

### BRIEF SUMMARY OF THE INVENTION

A method and system for managing real estate purchase transactions is provided. In one exemplary embodiment, the system collects various types of information relating to real estate purchase transactions. The system then tracks various milestones under a real estate purchase contract and provides automated alerts to one or more users. The system further allows different users with varying functional roles to monitor their respective real estate purchase contracts.

In one exemplary embodiment, a system for managing a real estate purchase transaction is provided comprising: control logic configured to receive information from a buyer; control logic configured to create a contract using the received information; control logic configured to generate one or more milestones associated with the contract; and control logic configured to monitor the one or more milestones associated with the contract to ensure their completion during the real estate purchase transaction.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating the architecture of an exemplary embodiment of the present invention;

FIG. 2 is a simplified flow diagram illustrating a transaction flow of the system in accordance with one exemplary embodiment of the present invention; and

FIGS. 3-35 are illustrative screenshots illustrating the various functionality of the system in accordance with one exemplary embodiment of the present invention.

### DETAILED DESCRIPTION OF THE INVENTION

The present invention in the form of one or more exemplary embodiments will now be described. An exemplary embodiment of the present invention is a system that is implemented using computer software. In one exemplary aspect, the system is a web-based application designed to streamline the entire sales cycle for the homebuilder or residential developer. The system is designed to track every phase of the new home sales cycle from the initial contact by the prospective buyer, to the selection of upgrades and options, throughout escrow and the entire warranty period. The system allows the homebuilder/developer to remain fully apprised of every aspect of the escrow process. To successfully close escrow, there are numerous milestones that both buyer and seller must satisfy in order to avoid falling out of contract. In other words, the failure of a party to complete one or more of the milestones may allow the other party to terminate the purchase contract. The system centralizes information and tracks communications between the homebuilder/developer and the buyer. As a result, potential problem areas are easily identified, tracked, and documented, and the potential of missed deadlines is dramatically reduced. The system also enables the homebuilder to better manage risks that may arise during escrow, thereby enhancing the probability of a successful home sale.

During the real estate transaction process, several persons need to interact with the system to complete the business cycle. Due to multi-user diversity, the system is designed to support a multitude of functional roles which may be present in a real estate purchase transaction, as further described below. A single user may fill one or more of these functional roles.

Home buyer—buyers occupy up to three status types within the system: prospective buyer, buyer in escrow, and buyer (who has completed the purchase) under warranty.

Seller's agent—this agent either works for or represents the developer. This person is responsible for entering prospective buyer data and offer/contract information into the system and managing contract flow throughout escrow and warranty phases.

Buyer's agent—this agent represents the purchaser of the house by generating the initial offer. This agent may or may not represent the developer.

Sales manager—this person is typically an employee of the developer. This individual manages the sales staff and oversees all variables, such as options and upgrades for the complement of available home plans. This person typically has access to walk-through, and contract reports for all developments under his/her supervision.

Escrow agent—this person is typically an employee of a title company. This individual is responsible for implementing and monitoring the escrow account.

General manager—this person is either the owner or an executive of the developer. This individual typically has access to all contracts and the ability to reply to offers and add comment notes within contracts.

Transaction controller—this person is an employee of the developer. This individual monitors status of construction, contracts, and warranty issues. Hence, this individual, this individual has the ability to track the status of all contract and warranty milestones.

Warranty administrator—this individual is responsible for handling all warranty problems. A printed to-do list of warranty issues is typically available to this individual, who may be either an internal or external employee.

Content administrator—this person is typically an employee of the developer. This person has access to site content setup and configuration in order to fulfill responsibilities for maintenance and upkeep of the system.

System administrator—this person is responsible for the management and performance of the system and has full access to all aspects of the system for each client under his/her supervision.

It should be understood that the above descriptions with respect to various functional roles in a real estate purchase transaction are provided for illustrative purposes only. A person of ordinary skill in the art will appreciate other functional roles that may be present in a real estate purchase transaction.

### System Overview & Architecture

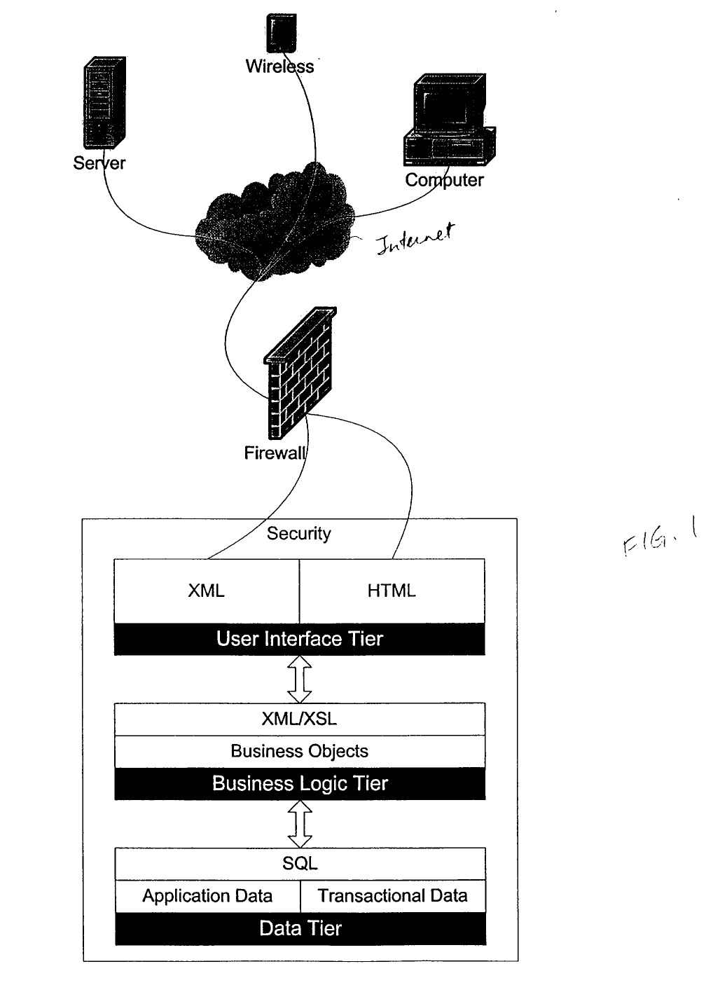

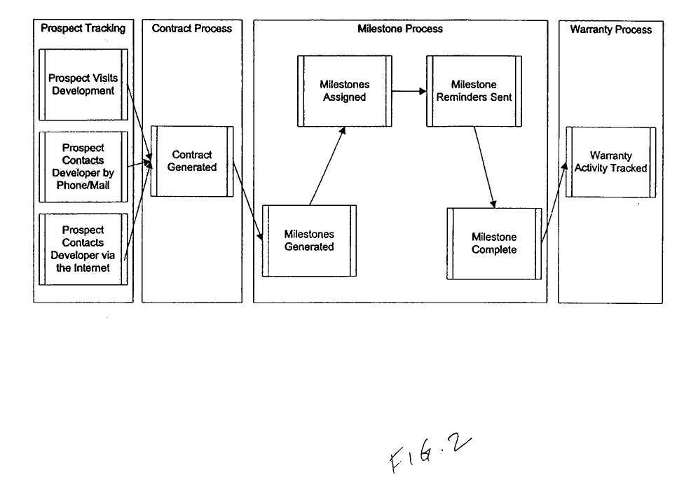

The system architecture defines the major components of the system, how they interact, and the technologies used to implement the system. In one exemplary embodiment, the design of system is based on the standard model recommended by Microsoft for n-tiered web applications. FIG. 1 is a simplified block diagram illustrating the architecture of an exemplary embodiment of the present invention

The system includes three tiers: the User Interface Tier, the Middleware/Business Logic Tier, and the Database Tier. The User Interface Tier presents the system to the user; the Middleware/Business Logic Tier contains the business logic in the form of Component Object Model (COM) objects; and, the Database Tier contains the data store. In one exemplary embodiment, each of these tiers is designed for hosting on separate servers, if necessary. Separation of these functions onto individual servers enables the system to scale in specific areas when those needs increase. For example, if client capacity increases and additional web services are required, the web server could be upgraded or modified without affecting the middleware or database servers. Each of these three tiers is further described below.

The User Interface Tier is the presentation layer of the system and contact point for clients and users. In one exemplary embodiment, this tier is served from a Microsoft Internet information server. The interface is developed to current browser standards and compatible with the most common and current browsers including backwards compatibility for Netscape Navigator v4.7 and Microsoft Internet Explorer v4.x. Communication is accomplished using Transmission Control Protocol/Internet Protocol (TCP/IP) over HyperText Transfer Protocol (HTTP) port and transactions are provided through 128-bit Secure Socket Layer (SSL) to ensure safe transmission of data between the client and the server.

Upon gaining access to the system via a website, users can enter and retrieve information based on their security levels. The system offers a number of features. For example, the web pages use a combination of HyperText Markup Language (HTML) and scripting code. Data entry forms contain logic to perform data validation before information is submitted to the server. These forms provide standard entry options, such as, drop-down lists or checkboxes to minimize data entry errors, duplicated data and misspellings and standardize input. The user interface of the website is intuitive and user-friendly.

The system further includes a complete on-line help system to assist users. Appropriate links are placed at relevant points throughout the process providing contextual help. Navigation is dynamic and responsive according to the type of user accessing the website.

The Middleware/Business Logic Tier executes the business rules of the system and is written using standard application components based on the Component Object Model (COM). COM objects are grouped into several sub-layers that separate the front-end objects from the database connection objects. This approach creates a more secure and efficient design. Functions that this tier perform include, for example, data parsing, transformation, formatting and validation, database requests, security validation, and error handling.

Typically, a request from the User Interface Tier is interpreted by the web service and passed to this tier for action. This request is in the form of a call to a specific COM object with parameters. An example would be passing the username and password of a user in the login process for security validation. An object interprets the passed values, creates a Structure Query Language (SQL) query using these values and makes a call to a database connection object. The database connection object is responsible for opening a connection to the database, passing the SQL query and receiving the result from the database. Results are formatted and returned to the user interface.

In addition to being the data store for the system, the Data Tier provides routines that preserve the integrity of the data. The data design is modeled to take advantage of relational database rules and provides standard features such as transaction commit and rollback, backup and restore, Open Data Base Connectivity (ODBC) interface, and a graphical SQL interface. This architecture facilitates additions and changes without requiring any significant application engineering or redesign.

The security and integrity of the data entered and manipulated by system is preserved at every step. Security is implemented at several points or areas throughout the system. These areas include, for example, user interaction, middleware, database, and physical security.

With respect to user interaction, the system has a login password policy. The system requires all users to login with a valid user name and password to gain access to the system. All activities are kept in an audit log and available by report to appropriate persons.

Via an administration module, the system allows client users to configure various password policies, including minimum password length, username formats, change frequency, restricted obvious passwords (like “password”), and not sharing or revealing passwords to anyone. Passwords are never revealed on the screen at any time. When passwords are entered, they appear as asterisks instead of plain text.

In addition to creating individual user accounts, all elements of the system are assigned an appropriate access level. Menus and other options throughout the system are filtered based on the user's identity and level of access.

Client administrators have the option to either auto-generate the user account and password information from the system, or specify a default password.

User sessions on the server are timed out after some specified period if there is no activity. This is to minimize unauthorized use of unattended workstations.

Accounts that have not been accessed for a specified time period are flagged as inactive. Inactive accounts require the system administrator to reactivate them.

The system further provides an audit log. Content upload and content editing are kept in this log. Content revisions are also logged for rollback and revision control.

With respect to middleware security, the middleware is implemented using Microsoft's Component Object Model (COM) in a defined tier containing all of the business logic and rules of the system. Therefore, the web front end only contains basic HTML forms and some scripting to control page functionality. The system is designed with separate set of objects that handle requests and traffic from the user interface (UI objects), and a separate set that handles connections and interaction with the database. Encryption is utilized ensuring the security of the data. The COM model provides an application interface for interaction with other applications and all interfaces are clearly documented.

With respect to database security, in addition to the standard securities features of the SQL server, like transaction commit and rollback, the system limits access to the database to only specified objects in the middleware. If a connection is attempted from any other source, the connection is refused.

All other services on the server are tuned to limit the number of ways that the server may be accessed. Connections to the database itself require a specific username and password for access. This account is configured so that it has very limited functionality to the database. If the account is compromised, the intruder's access is limited to a finite cluster of functions.

In one exemplary implementation, the system is implemented using control logic in the form of software code and/or instructions in a modular or integrated manner. Based on the disclosure and teachings provided herein, a person of ordinary skill in the art will know of other ways and/or methods to implement the present invention.

### Business Flow and Logic

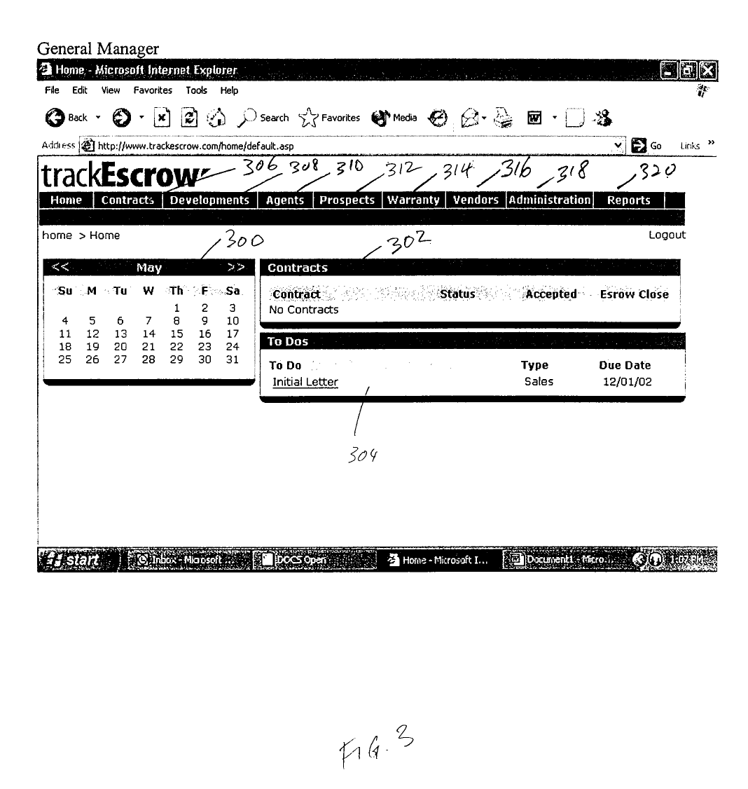

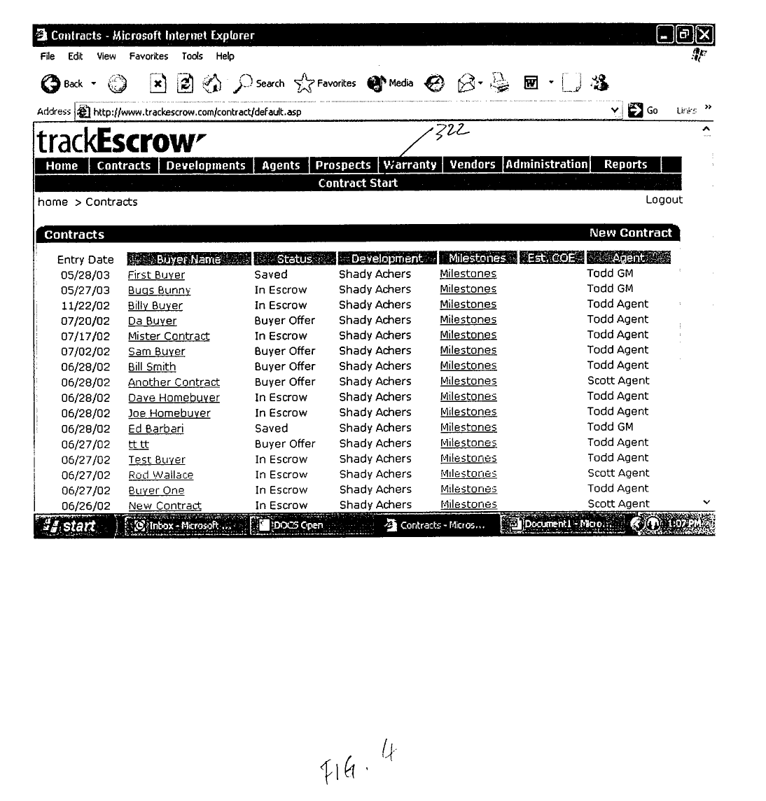

FIG. 2 is a simplified flow diagram illustrating a transaction flow of the system in accordance with on exemplary embodiment of the present invention. The transaction flow includes a prospect tracking process, a contract formation process, a milestone monitoring process and a warranty monitoring process.

The process begins when the prospective home buyer (prospect) contacts the developer. Typically, the prospect visits the development and either fills out a visitor interest card or, if time allows, fills out a more detailed interest sheet with the sales agent. The prospect may also contact the sales agent by phone or mail. The sales agent then collects relevant information from the prospect. The prospect may provide information such as, the prospect's name, contact information, preferred lot and house plan, the name of the prospect's agent, and any other relevant information. This information is entered into the system. Alternatively, the prospect may supply the information to the system via the Internet.

Once the information is input into the system, the system generates relationship-building reminders at predetermined intervals, based on the information provided by the prospect, such as, the prospect's level of interest and the developer's marketing strategies. For example, the system may periodically prompt the sales agent to follow up with a prospect via email or other forms of communications. Subsequent communications between the agent and prospect may be logged in, as well.

Once the prospect decides to purchase a home, the seller's agent enters additional relevant contract information, for example, down payment, initial deposit, and selection of options, into a contract form provided by the system. The contract form provided by the system is customized to fit the needs and desires of a particular developer. Hence, the system may have different contract forms accommodating different developers. Upon completion of the contract form, the system generates a completed contract. The system displays the completed contract in Rich Text format in a browser window. The completed contract can then be printed for review by the prospect.

Once the seller's agent verifies that the printed contract has been signed by the prospect, notification is sent, for example, via email, to the sales manager and/or general manager. At this stage in the process, the executed contract represents an offer that has been made by the prospect to the developer. A predetermined time limit is set on the offer by the system. The system generates reminders that are sent, for example, via emails, to all involved parties regarding the approaching expiration date of the offer. In this manner, the system ensures that offer does not lapse due to oversight.

If the contract is accepted by the developer, the date of acceptance (DOA) is set in the system and all contract milestones are set. These milestones may then be assigned to various parties with different functional roles, such as, the sales agent, buyer, sales manager, general manager and/or transaction controller. Milestones are predetermined by the developer for each contract. Milestones may be stand-alone, based on the DOA, or linked to the completion of related milestones. Based on the disclosure and teachings provided herein, a person of ordinary skill in the art will appreciate how to generate and/or assign milestones in accordance with the present invention.

The system allows the status of all milestones for a given contract to be viewed. In order to provide ease of differentiation, the background color of a milestone pending completion is white; one that is past due is red; and a completed milestone is shaded with a blue background.

All users of the system have access to a calendar of all milestones that have been assigned to them. The system generates and delivers appropriate milestone reminders to relevant users at intervals predetermined by the developer. Past due reminders also appear as well.

After the close of escrow (COE), there is a warranty period for each new home. The duration of any warranty is determined by local, state, and/or federal law. During this period, a new homeowner is entitled to make warranty requests of the developer. The system validates the warranty and generates work orders with a unique identifier. The work order is assigned to either an employee or an external subcontractor. All communications and information relating to the warranty is entered into the system. The status of any warranty may be viewed by anyone who has access to that specific warranty issue. If the warranty is not completed within a predetermined time, reminders are sent by the system to the warranty administrator and pertinent individuals.

All relevant warranty issues are entered into the system, allowing the progress of each item to be tracked through completion. Because it is designed to identify and notify any individual vendor/sub-contractor responsible for a given warranty item, the system dramatically streamlines the demands of this phase.

A full series of standard reports are available from the system. These reports track a number of different statistics including, for example, the number of walk-throughs at a development, projected revenues from existing contracts, and the number of warranty issues per development. When deemed appropriate, the ability to create custom reports is available.

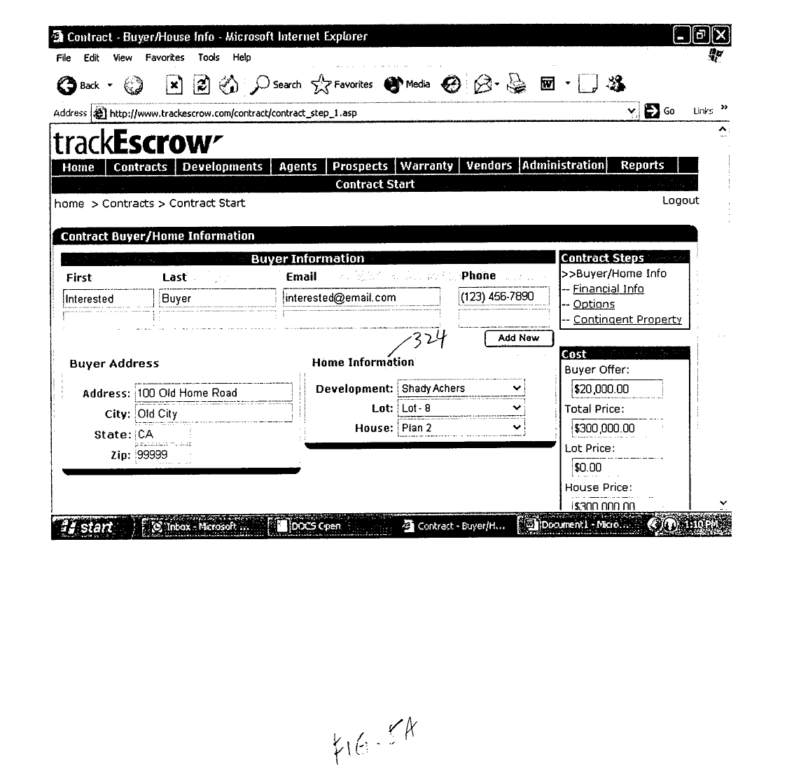

The functionality of the system is further described below. FIGS. 3-35 are illustrative screenshots illustrating the various functionality of the system in accordance with one exemplary embodiment of the present invention. As mentioned above, the system allows different users having different functional roles in the real estate purchase transaction to participate. FIGS. 3-32 are screenshots illustrating exemplary functionality that is offered by the system to a general manager.

In FIG. 3, there is shown a calendar area 300, a contract area 302 and a To-Do area 304. The calendar area 300 includes a calendar that allows the general manager to view events on selected dates. The contract area 302 provides a list of contract that the general manager is directly responsible for managing. For each contract listed, the corresponding status on various items, such as, acceptance status and escrow status, are shown. In FIG. 3, no contracts are shown in the contract area 302 for this particular general manager. The To-Do area 304 provides a list of tasks that is to be completed by the general manager. These tasks are generated by the system when certain events occur, such as, when contracts were completed, offered and/or executed. Information relating to each task is also displayed, such as, type of task and its due date. Additional information relating to the task may be available and viewed by clicking on the hypertext link corresponding to that task. In addition, the general manager can also use the system to perform functions in various other areas including “contracts” 306, “developments” 308, “agents” 310, “prospects” 312, “warranty” 314, “vendors” 316, “administration” 318 and “reports” 320, as will be further described below.

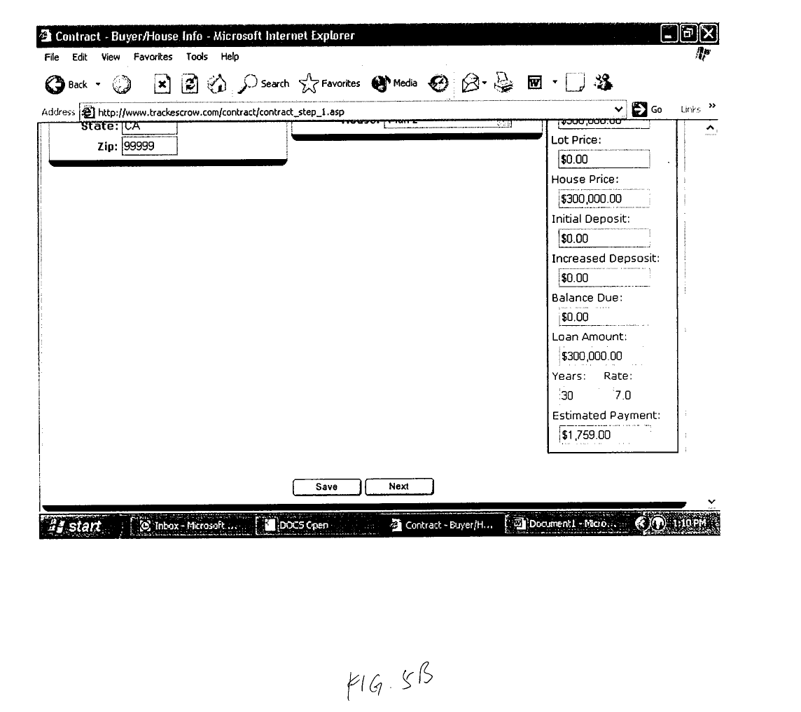

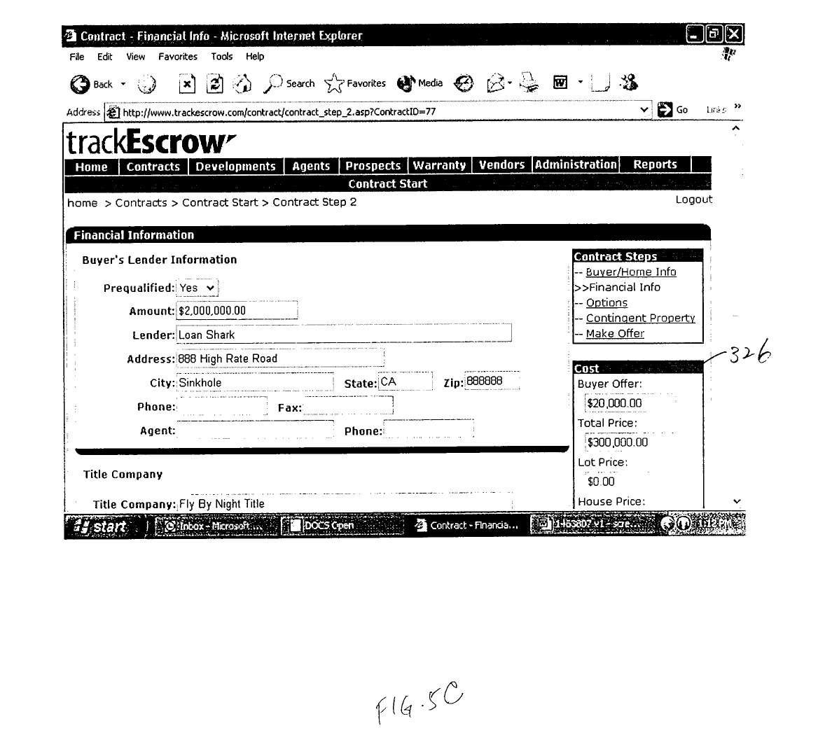

FIG. 4 illustrates the functionality offered to the general manager when the “contracts” 306 area is selected. With this functionality, the general manager is able to view all the contracts that s/he is responsible for. In one arrangement, a general manager may be responsible for all the contracts relating to a particular developer. In one exemplary situation, the system is used by a developer to monitor its real estate purchase transactions. The general manager of the developer is responsible for monitoring all the contracts for the developer. As shown in FIG. 4, the general manager can view a list of contracts and the associated information. Additional information for each contract can be viewed by clicking on the corresponding hypertext link. For example, if the general manager wishes to see more information for a particular buyer, the general manager can just click on the corresponding “buyer name” hypertext link for that particular buyer; or if the general manager wishes to see the milestones and their respective status associated with a contract, the general manager can simply click on the corresponding “milestones” hypertext link for the desired milestones. Furthermore, the general manager can also initiate the process of filling out a contract by clicking on the “contract start” hypertext link 322. As will be further described below, the process of filling out the contract involves a number of steps.

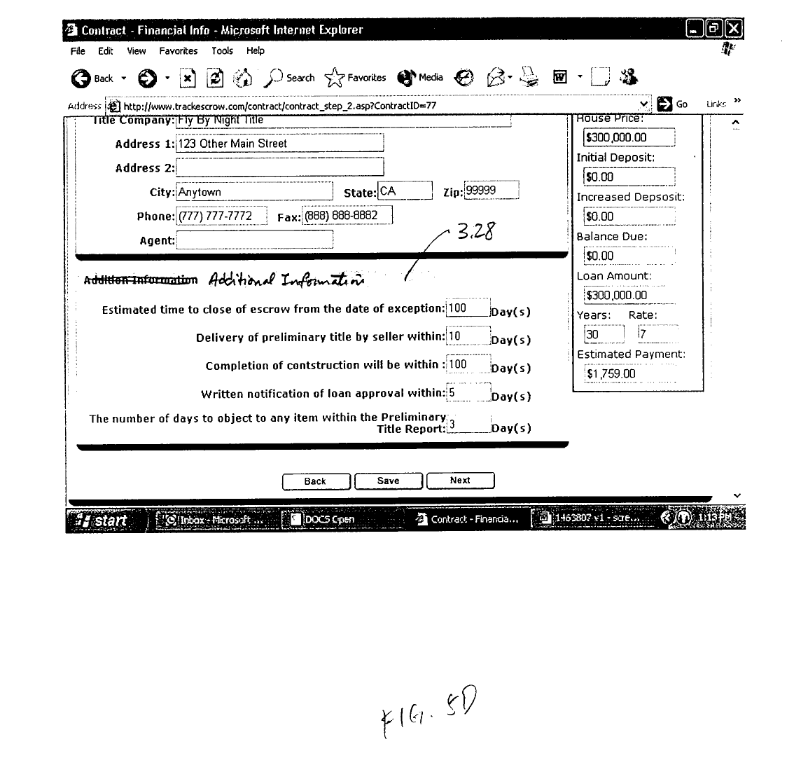

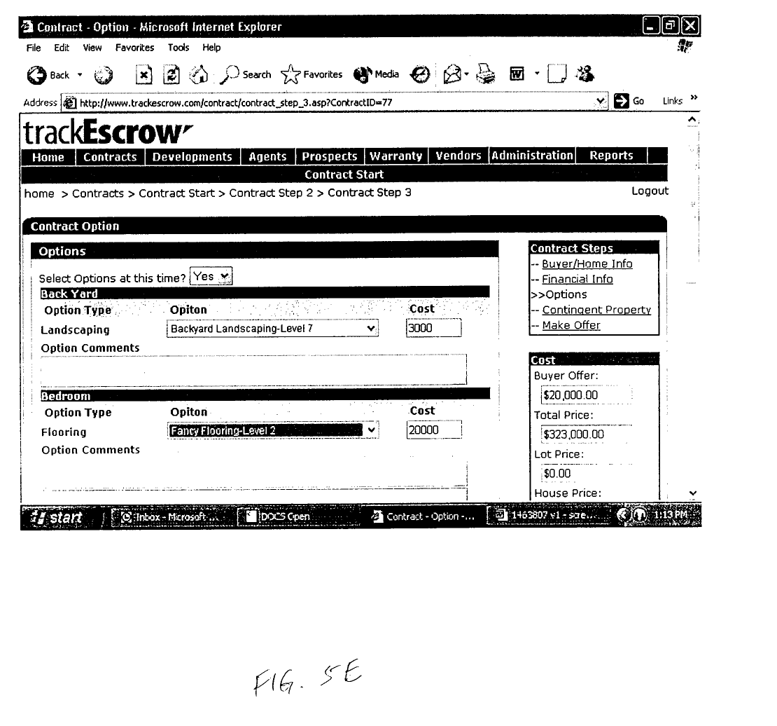

FIGS. 5A and 5B collectively illustrate the first step of the process of filling out the contract. In this step, the buyer provides the relevant information to the system. Such information includes, for example, name, contact information, address and information relating to the desired property. For example, in FIG. 5A, the buyer can use the “Home Information” area to select the desired development, lot and house. Pull-down menus are available to allow the buyer to make the desired choices.

FIGS. 5C and 5D collectively illustrate the second step of the process of filling out the contract. In this step, the buyer provides the relevant lender and financial information. A “cost” area 326 allows the buyer to input financial information. The financial information is then used by the system to calculate estimated costs and other relevant information. Additionally, the buyer can provide information on the title company as well as other additional information. For example, in FIG. 5D, such additional information is collected in the “additional information” area 328. Such additional information includes, for instance, estimated time to close of escrow, delivery of preliminary title, etc. This information may then be used by the system to generate the appropriate milestones for this contract.

FIGS. 5E and 5F collectively illustrate the third step of the process of filling out the contract. In this step, the buyer is able to select various options for the desired property. For example, in FIG. 5E, the buyer is able to select options for the backyard and bedroom. Pull-down menus are available to allow the buyer to make the desired choices. Similarly, additional information can be supplied by the buyer. For example, in FIG. 5F, the buyer can specify timelines in connection with delivery of options in the “additional information” area 330.

FIG. 5G illustrates the fourth step of the process of filling out the contract. In this step, the buyer may optionally provide information on the contingent property. The contingent property is the property that the buyer needs to sell before the purchase can be consummated.

FIGS. 5H, 5I and 5J collectively illustrate the fifth step of the process of filling out the contract. In this step, all the information collected in the previous steps is propagated into a completed contract. Summary information is displayed to the buyer on-screen and the entire completed contract is delivered to the buyer electronically. The buyer can then print out and review the completed contract. If the buyer approves the completed contract, the buyer can then indicate his/her approval by clicking on the “make offer” button 332. In FIG. 5J, the system prompts the buyer to confirm his/her offer.

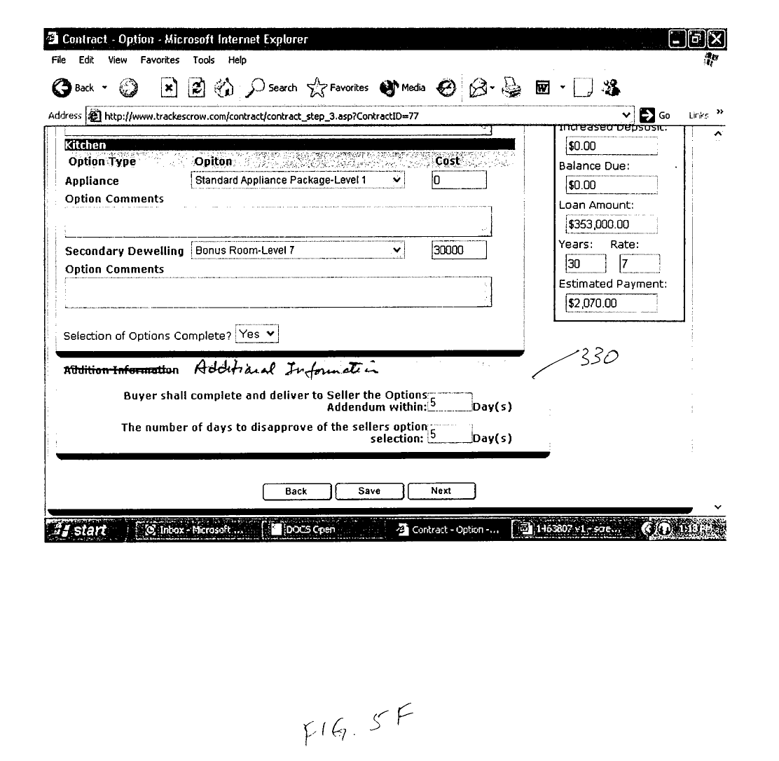

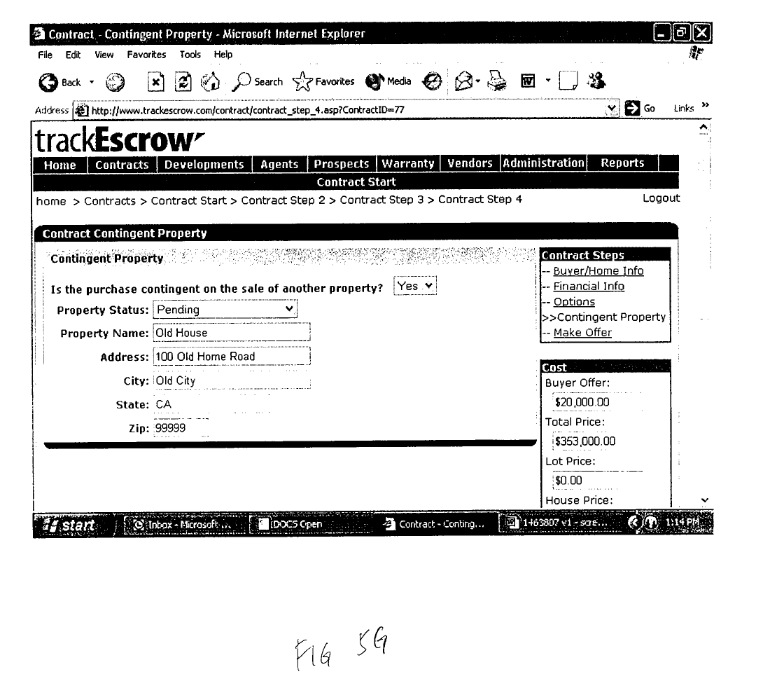

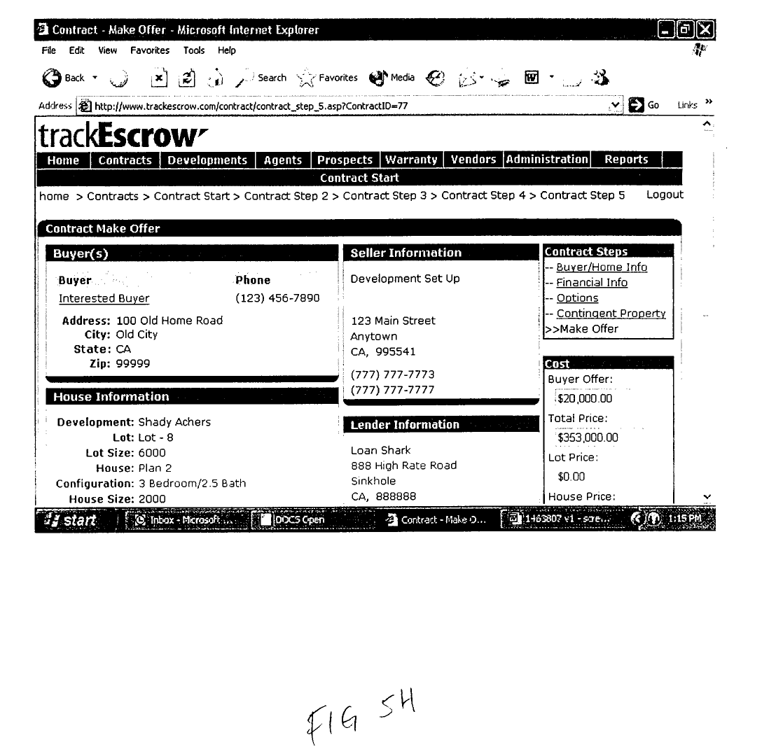

Once the contract is offered, the system stores the contract and generates the associated milestones. As described above, the general manager can select a particular contract for viewing as illustrated in FIG. 4. FIG. 6 illustrates the contract details when the general manager selects a particular contract. As shown in FIG. 6, the general manager can further view additional information relating to the contract and perform a number of functions by clicking on the corresponding hypertext links, such as, “accept offer”, “counter offer”, “contract print”, “cancel contract”, “lender”, “title company” and “contingent property”. For example, the general manager may accept the offer by clicking on the “accept offer” hypertext link. FIGS. 7A and 7B collectively illustrate the screen that is shown when the “accept offer” hypertext link is activated. The general manager can view additional information relating to the contract and, if acceptable, choose to accept the contract by clicking on the “accept offer” button 334.

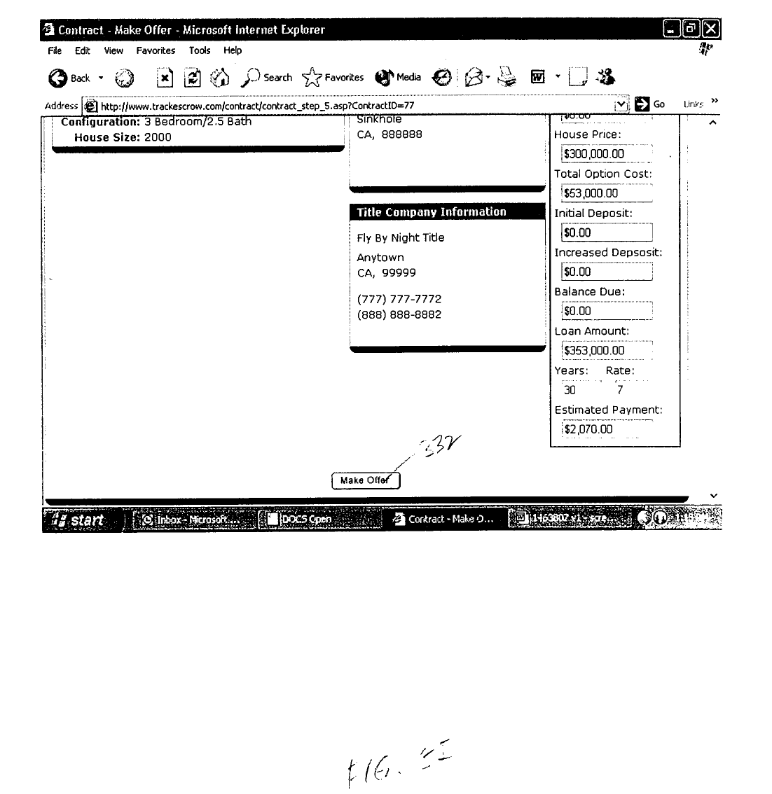

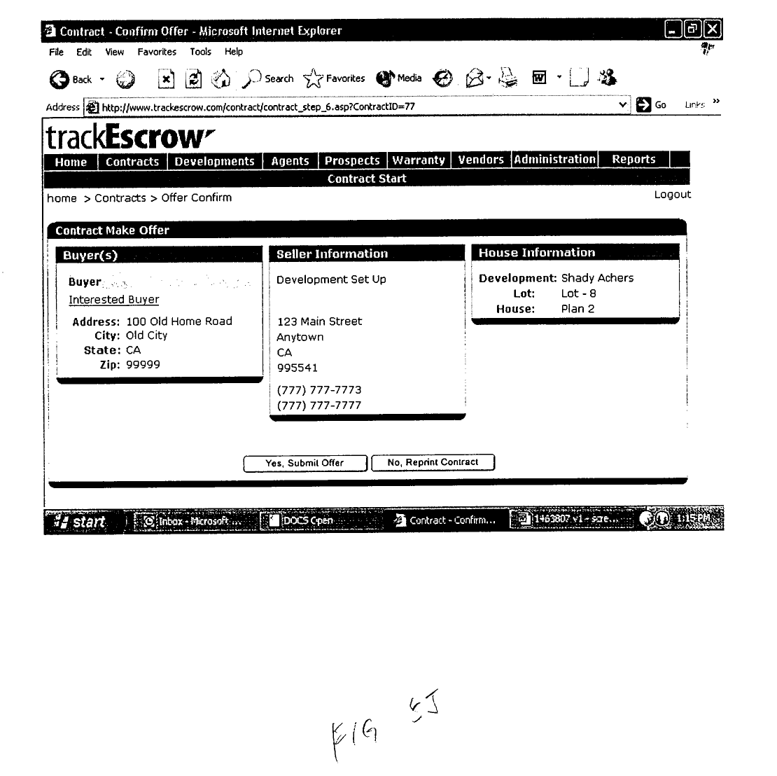

FIGS. 8A and 8B collectively illustrate the summary information that is displayed when the contract is accepted. When the contract is accepted, the system generates the appropriate milestones associated with that contract. The milestones are then displayed to the general manager. In FIG. 8B, these milestones are shown in the “milestones” area 336. Additional information relating to a milestone may be viewed by clicking the corresponding hypertext link.

Referring back to FIG. 6, when viewing details of the contract, the general manager may also perform a number of other functions. For example, the general manager can make a counter offer to the contract offered by the buyer by clicking on the “counter offer” hypertext link; alternatively, the general manager can cancel the contract by clicking on the “contract cancel” hypertext link. The general manager can also obtain and review various types of information, such as, the entire contract, lender information, title company information and contingent property information.

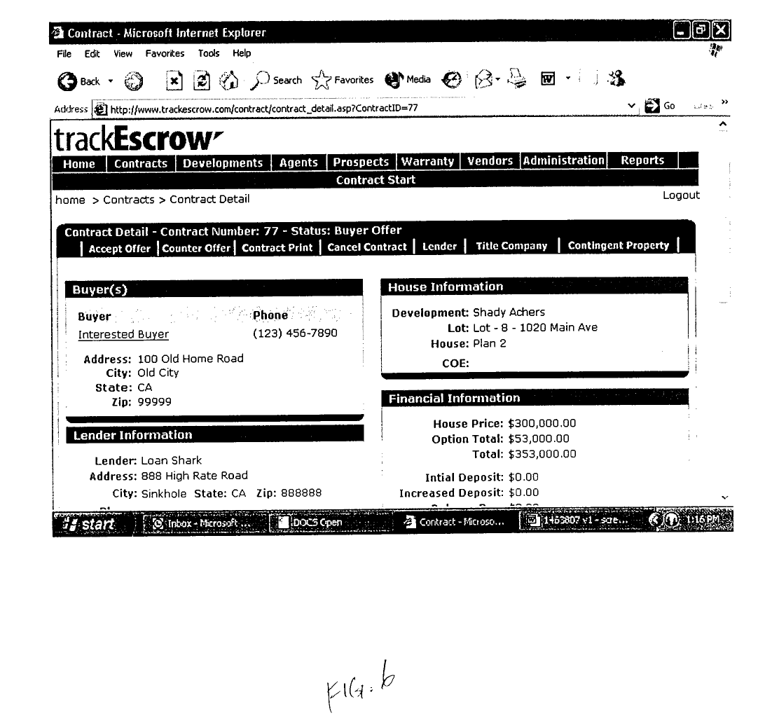

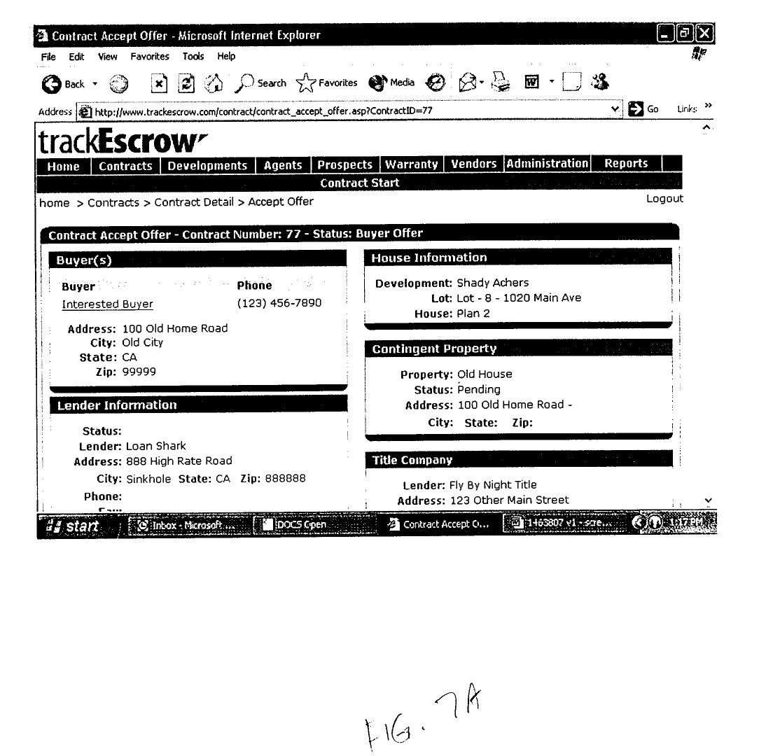

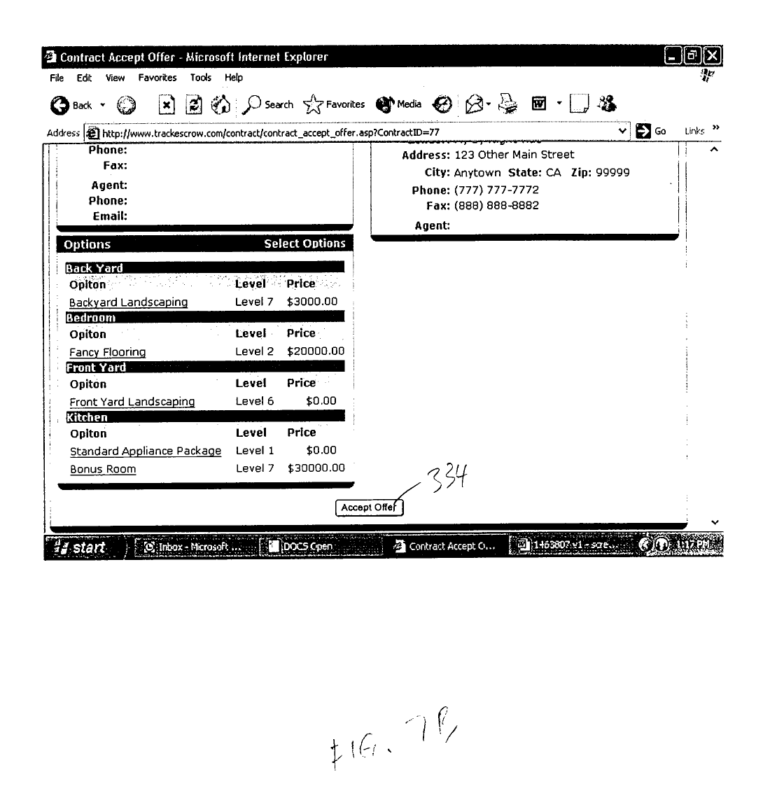

FIG. 9 illustrates another functionality offered by the system that allows the general manager to manage developments. As shown in FIG. 9, the “developments” area 338 allows the general manager to access and view information relating to different developments. If additional information is desired, the general manager can click on the corresponding hypertext link to view such information for the desired development. FIG. 10 shows the additional information that can be displayed when the hypertext link for a particular development is selected. As shown in FIG. 10, additional information for a particular development includes, for example, lots and houses within that development. Further information relating to the lots and houses can be obtained and viewed using the corresponding hypertext links. In addition, the system also provides functionality that allows the general manager to add new lots and/or houses.

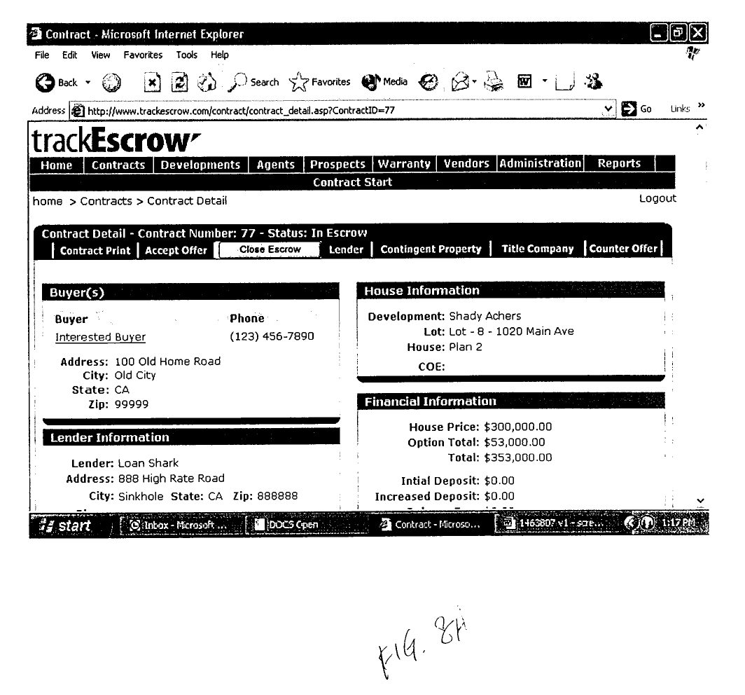

FIGS. 11A and 11B collectively illustrate the functionality offered by the system to allow the general manager to add a new house. As shown therein, the general manager can input information for a new house into the system, including for example, specification and cost information; the general manager can also input option information for the new house. FIG. 11C shows the information relating to the new house after the general manager has input it into the system. When viewing this information, the general manager has the option of modifying such information to the desired description or level. For example, the general manager can add and/or remove certain options that are available for a particular house.

As will be further described below, the general manager can also perform a number of functions with respect to developments, including for example, adding a development, managing a master option list, and managing option types.

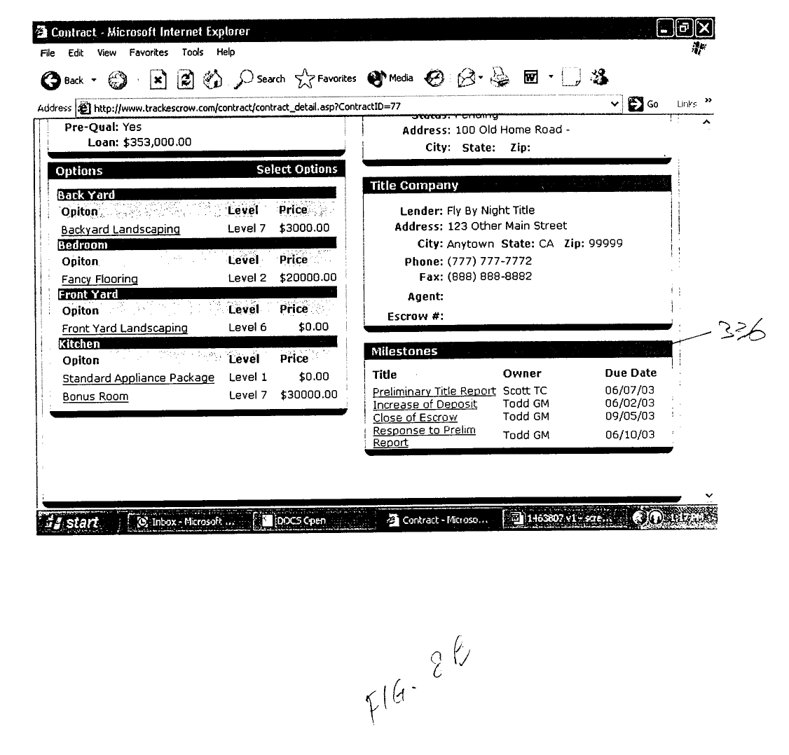

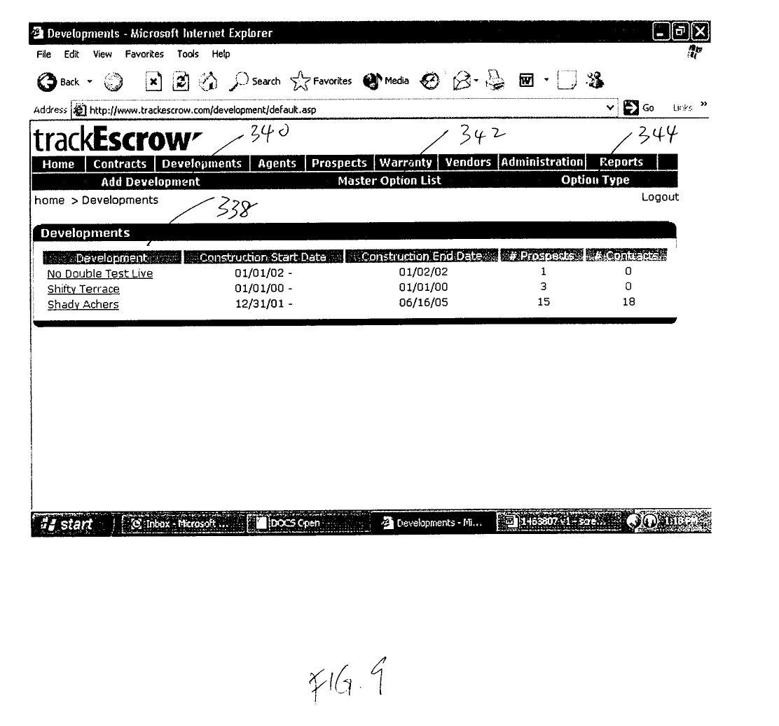

FIGS. 12A and 12B collectively illustrate the functionality offered by the system to the general manager to add a new development. Referring back to FIG. 9, the general manager can choose to add a new development by clicking on the “add development” area 340. FIGS. 12A and 12B collectively display a form that is used to collect information for the new development. Such information includes, for example, address and construction date information. Moreover, the system allows the general manager to assign and/or modify agents and/or transaction controllers to the new development.

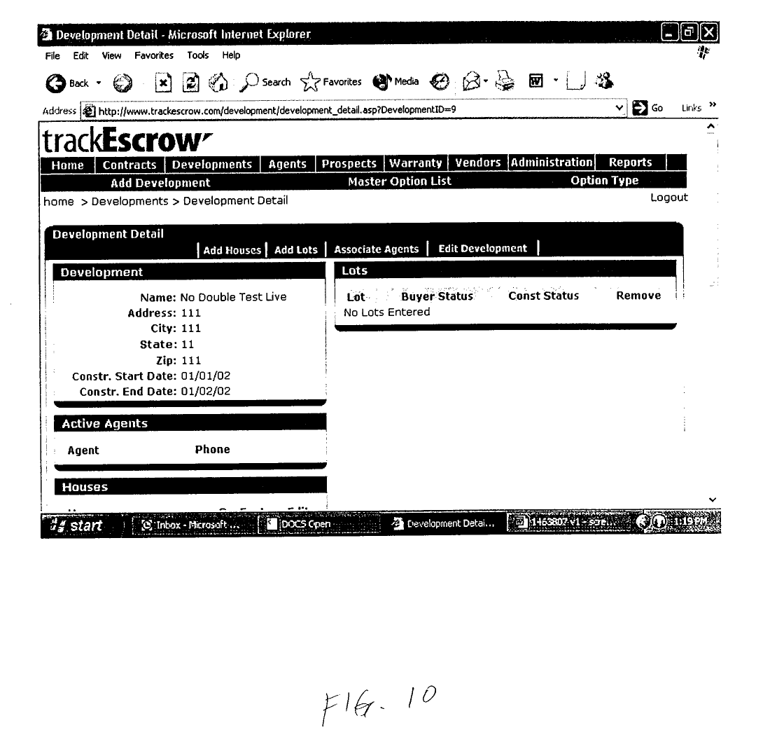

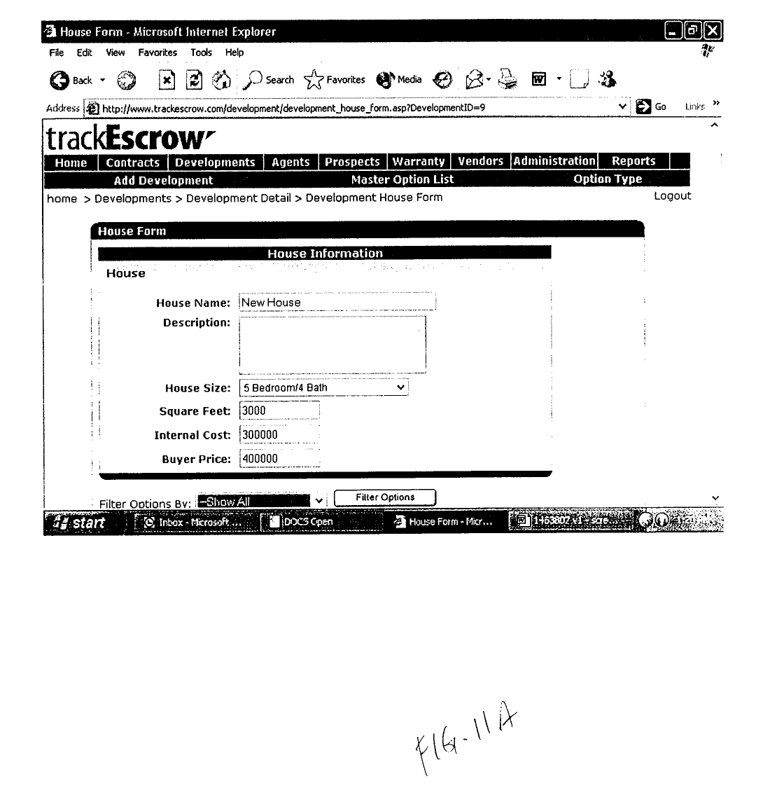

FIG. 13 illustrates the functionality offered by the system to the general manager to manage the master option list. Referring back to FIG. 9, the general manager can choose to access and modify the master option list by clicking on the “master option list” area 342. FIG. 13 shows the information displayed by the system when the “master option list” area 342 is selected. The option list provides a list of options that can be added to a house upon choosing by the general manager. When the general manager enters information on a new house into the system, the general manager can select options from this option list that the general manager chooses to make available for that house. Further information on each option can be viewed by clicking on the corresponding hypertext link for that option. In addition, additional or new options can be added to the option list by clicking on the “add options” hypertext link 346.

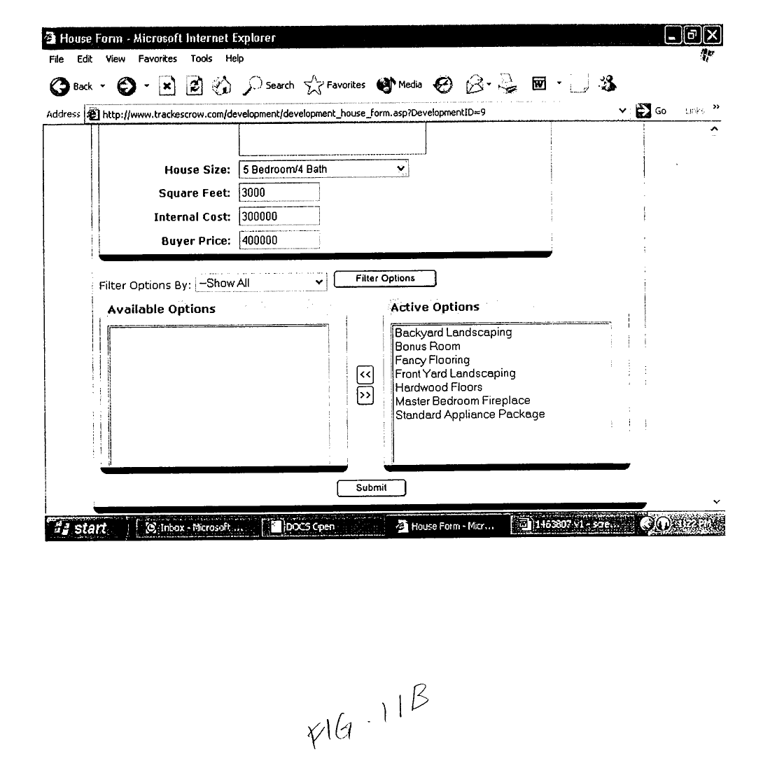

FIG. 14 illustrates an exemplary form displayed by the system when the “add option” hypertext link 346 is selected. The system allows the general manager to input information relating to a new option. Once the information is entered into the system, the added option is available on the master option list.

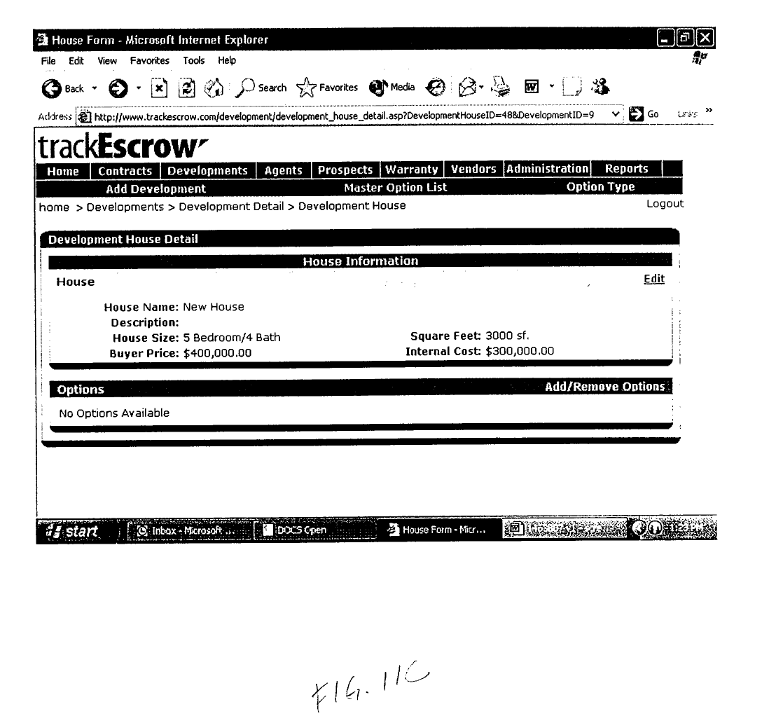

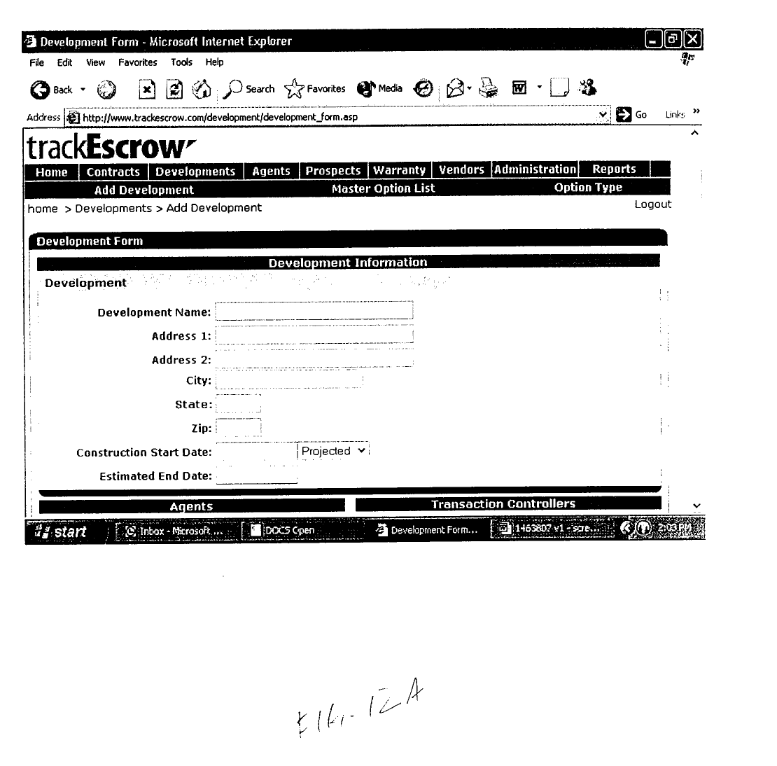

FIG. 15 illustrates the functionality offered by the system to the general manager to manage the option types. Referring to FIG. 9, the general manager can choose to access and modify the option types by clicking on the “option types” area 344. FIG. 15 shows the information displayed by the system the “option types” area 344 is selected. Such information includes, for example, different types of options that are available for categorizing various options. This allows different options belonging to the same category or option type to be organized and viewed. Additional information on an option can be viewed by clicking on the corresponding hypertext link for that option. Furthermore, the system allows the general manager to add new option types by clicking on the “add option types” hypertext link 348.

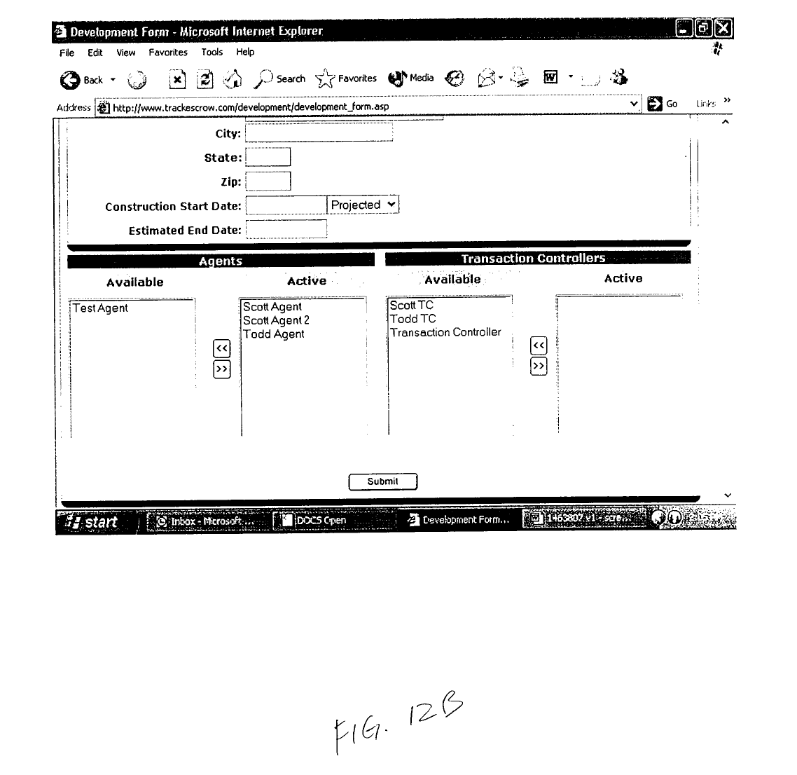

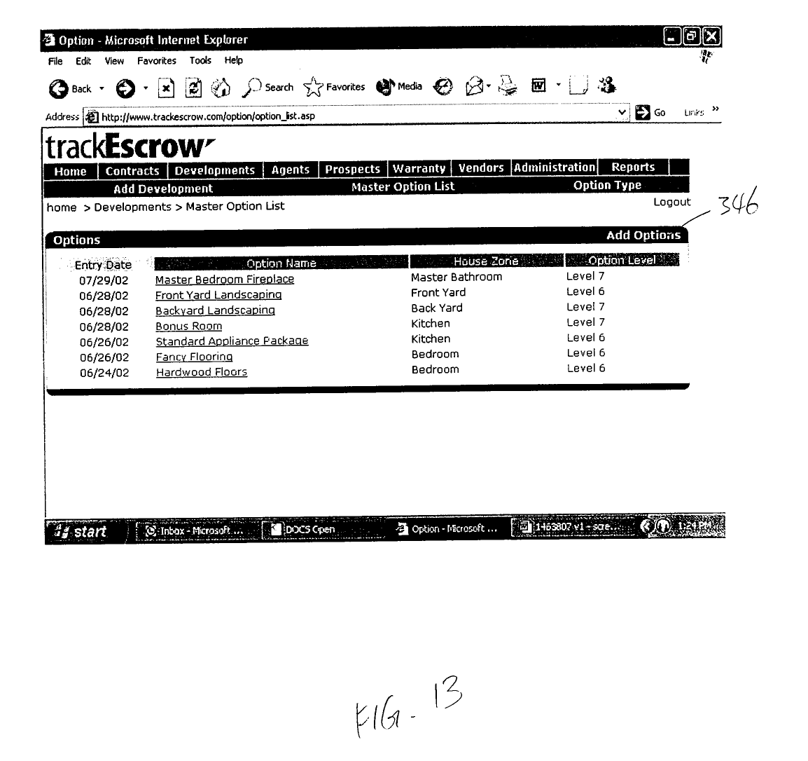

Referring back to FIG. 3, the general manager can select the “agents” area 310. FIG. 16 illustrates the functionality offered by the system to allow the general manager to manage a number of agents and sales managers when the general manager selects the “agents” area 310. As shown in FIG. 16, the general manager can view information relating to a number of agents and their respective sales managers. Furthermore, the general manager can deactivate or activate an agent by clicking on the corresponding hypertext link. Additional information relating to an agent or a sales manager can be viewed by clicking on the corresponding hypertext link.

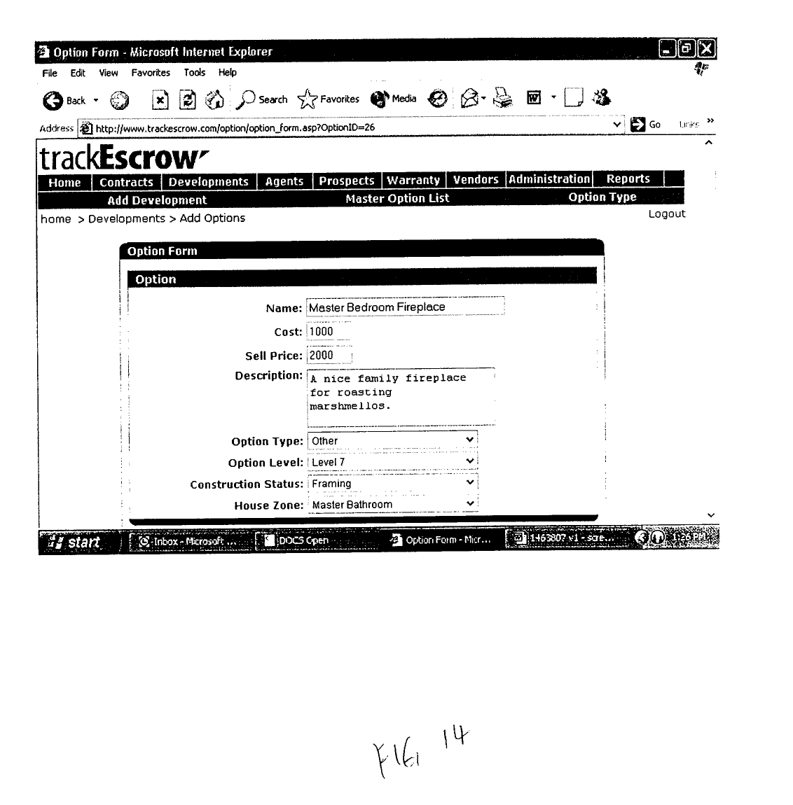

FIG. 17 shows the functionality offered by the system when a particular agent is selected by the general manager. Various types of information relating to the selected agent can be viewed by the general manager. For example, the system shows the developments that the selected agent has been assigned to. Information relating to a development associated with the selected agent can further be displayed by clicking on the corresponding hypertext link. In addition, the system also shows the list of contracts that the selected agent is currently working on. Various types of information relating to a contract, such as, buyer's name, development name, date of acceptance, and contract status, etc., can be shown by clicking on the corresponding hypertext links.

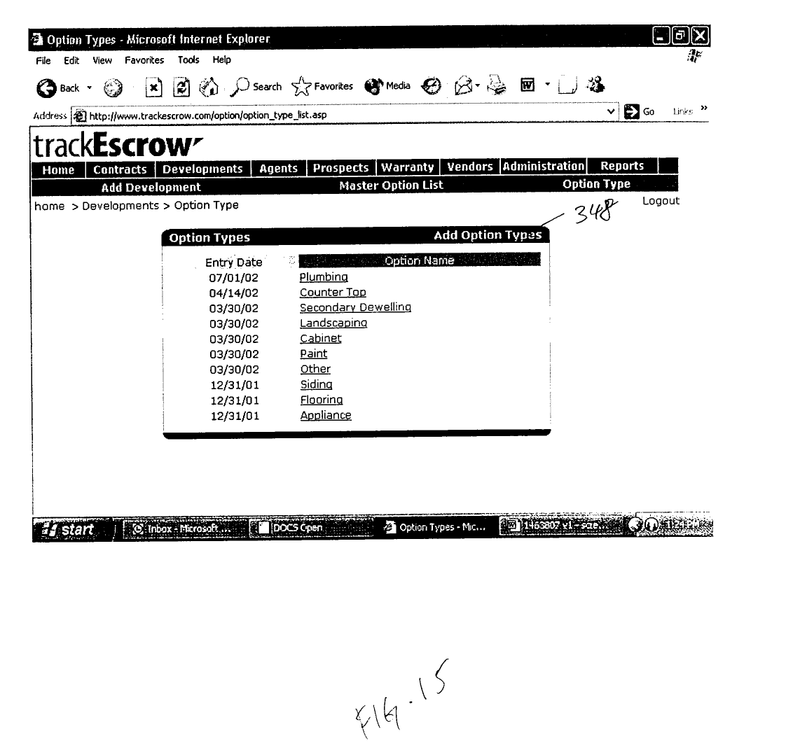

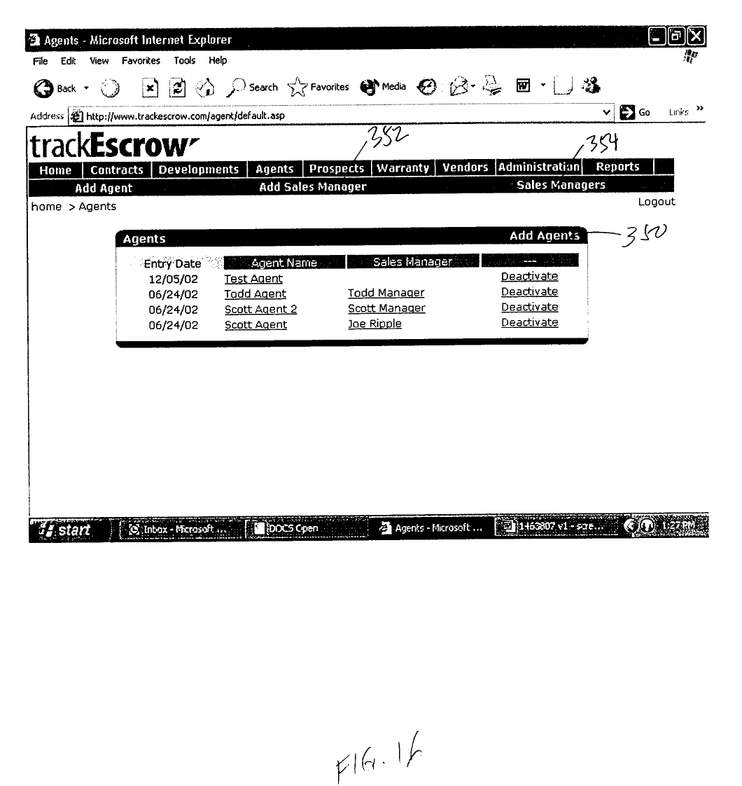

Referring back to FIG. 16, the general manager can also add an agent by clicking on the “add agent” hypertext link 350. FIGS. 18A and 18B collectively illustrate the functionality offered by the system when the “add agent” hypertext link is selected. As shown in FIGS. 18A and 18B, an agent form is displayed by the system to allow the general manager to input information relating to the agent being added. In addition to contact information relating to the added agent, the general manager can also specify the developments that have been assigned to that agent.

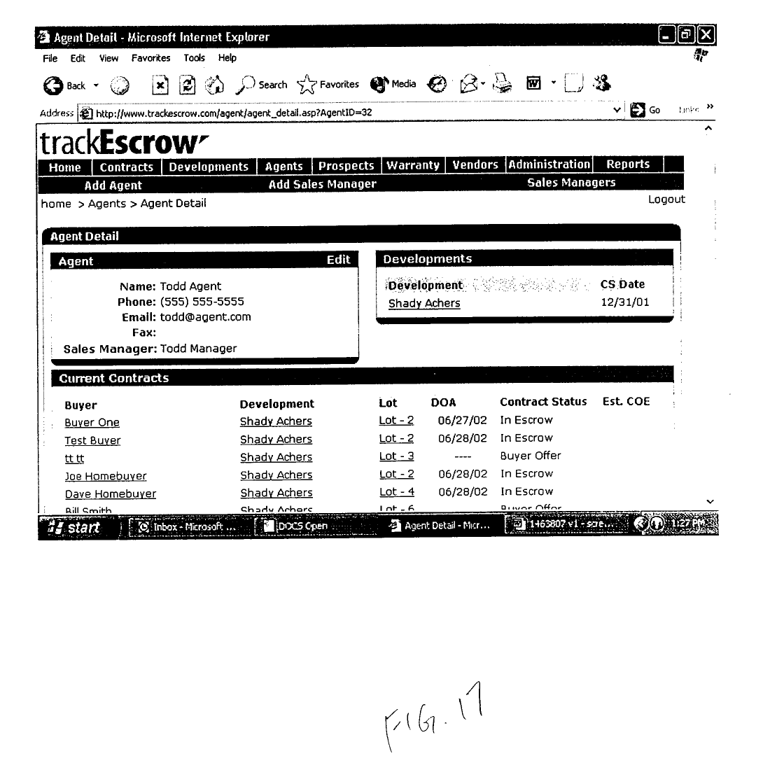

Moreover, as shown in FIG. 16, the general manager can further add a sales manager by clicking on the “add sales manager” hypertext link 352. FIG. 19 illustrates an exemplary form that is displayed by the system when the “add sales manager” hypertext link is selected. As shown in FIG. 19, in addition to contact information relating to the sales manager being added, the system also allows the general manager to designate or assign agents to the added sales manager.

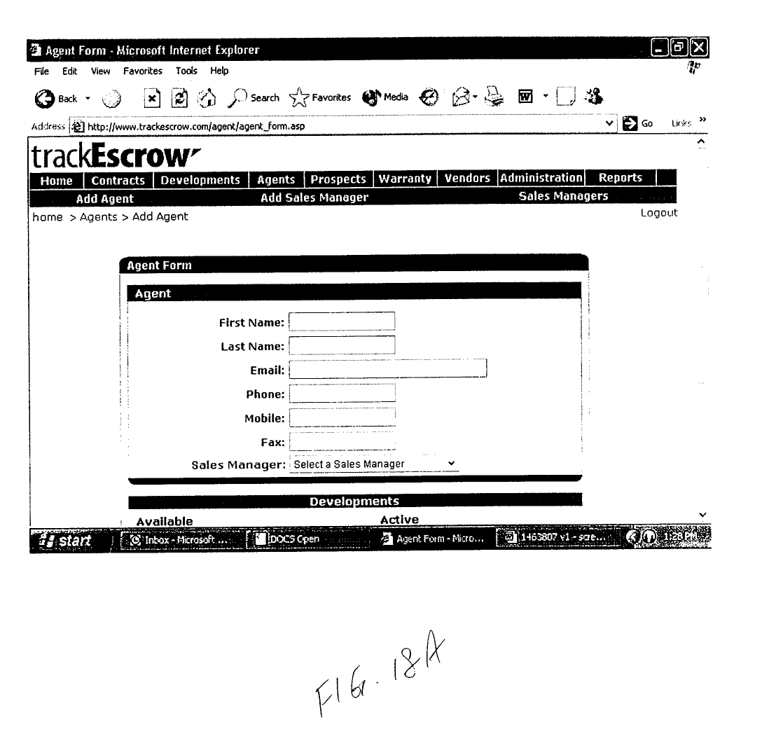

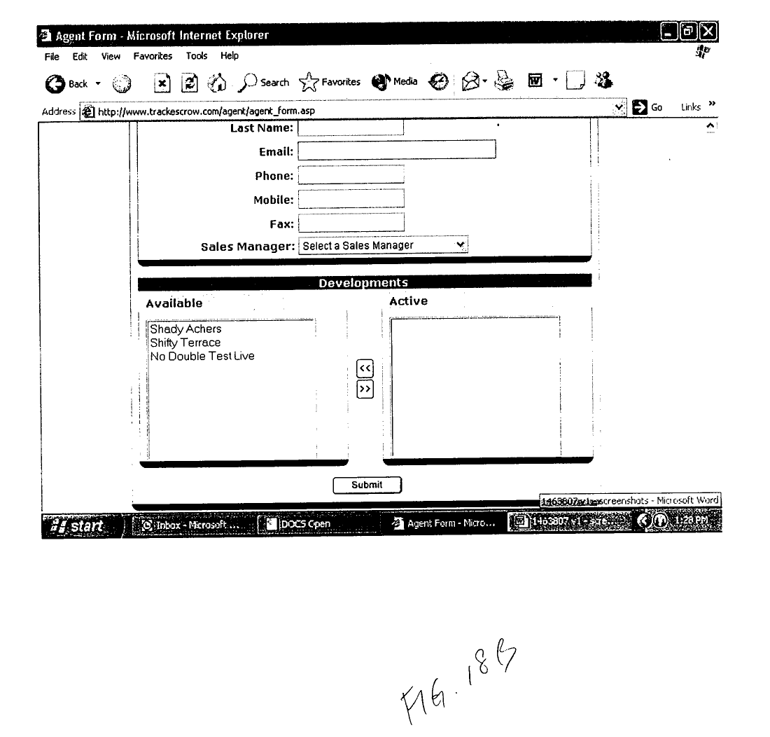

Furthermore, as shown in FIG. 16, the system allows the general manager to view information relating to a number of sales managers by clicking on the “sales managers” hypertext link 354. FIG. 20 illustrates the exemplary information that is displayed by the system when the “sales managers” hypertext link 354 is selected. Additional information relating to a sales manager can be obtained and viewed by clicking on the corresponding hypertext link.

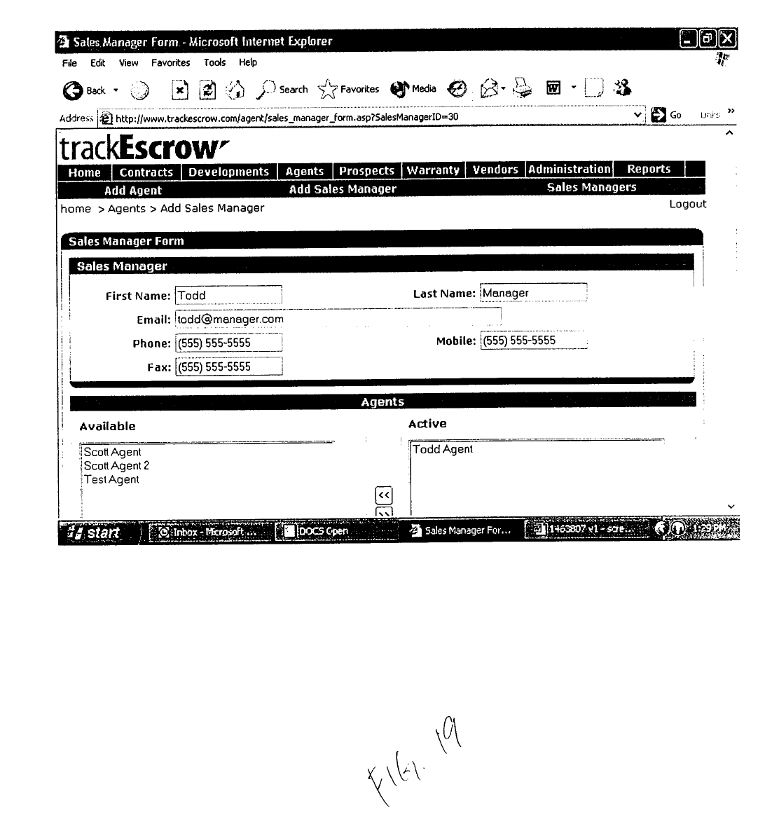

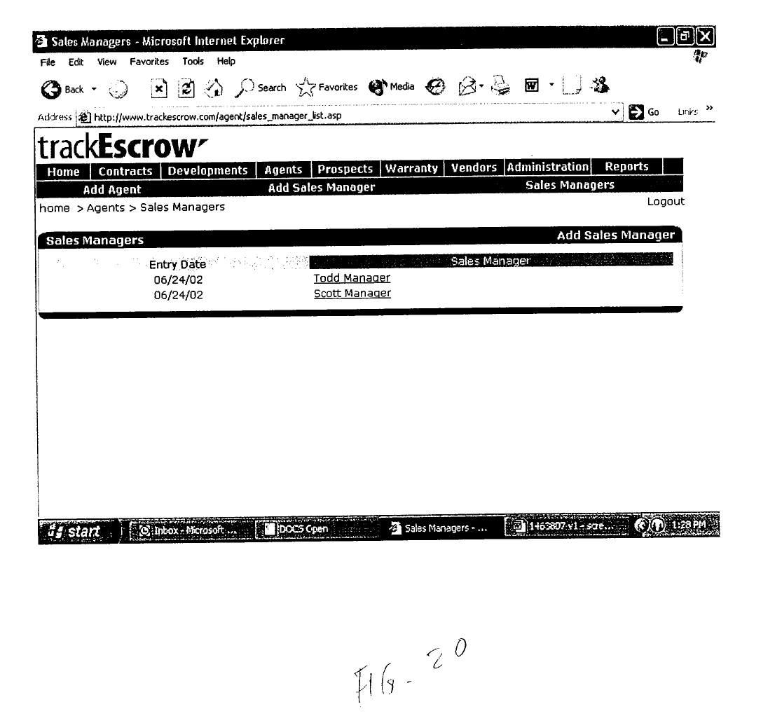

Referring back to FIG. 3, the general manager can select the “prospects” area 312. FIG. 21 illustrates the functionality offered by the system to allow the general manager to manage a number of prospects when the general manager selects the “prospects” area 312. As shown in FIG. 21, the general manager can view information relating to a number of prospects. Such information includes, for example, prospect name, development visited and visit date, etc. Additional information relating to a prospect can be viewed by clicking on the corresponding hypertext link.

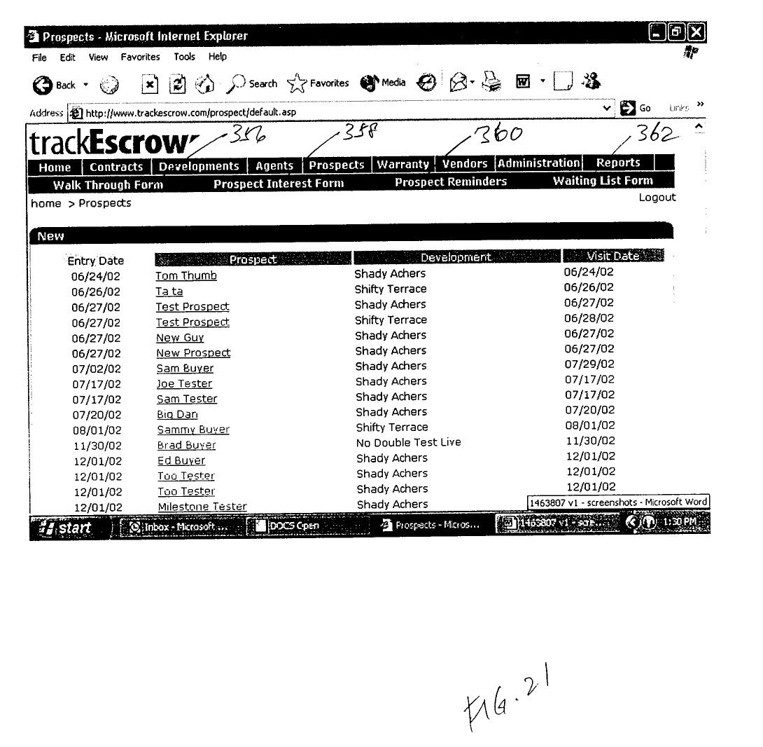

FIG. 22 illustrates the functionality offered by the system when the general manager selects to view a particular prospect. As shown in FIG. 22, in addition to general information relating to the prospect, the system also allows the general manager to view information relating to milestones and contact history for that particular prospect. The milestones relate to tasks that are to be performed to follow up with the prospect in order to maintain the interests of the prospect. Additional information on a milestone can be obtained by clicking on the corresponding hypertext link. By allowing access to the milestones and contact history, the general manager can ensure that proper follow-up activities are performed by the agents and/or sales managers to maintain the interest level of the prospect thereby maximizing likelihood of a successful sale.

As shown in FIG. 21, the system further offers a number of other features to allow the general manager to capture and track information concerning a prospect, including a “walk-through form” 356, a “prospect interest form” 358, “prospect reminders” 360, and a “waiting list form” 362, as will be further described below.

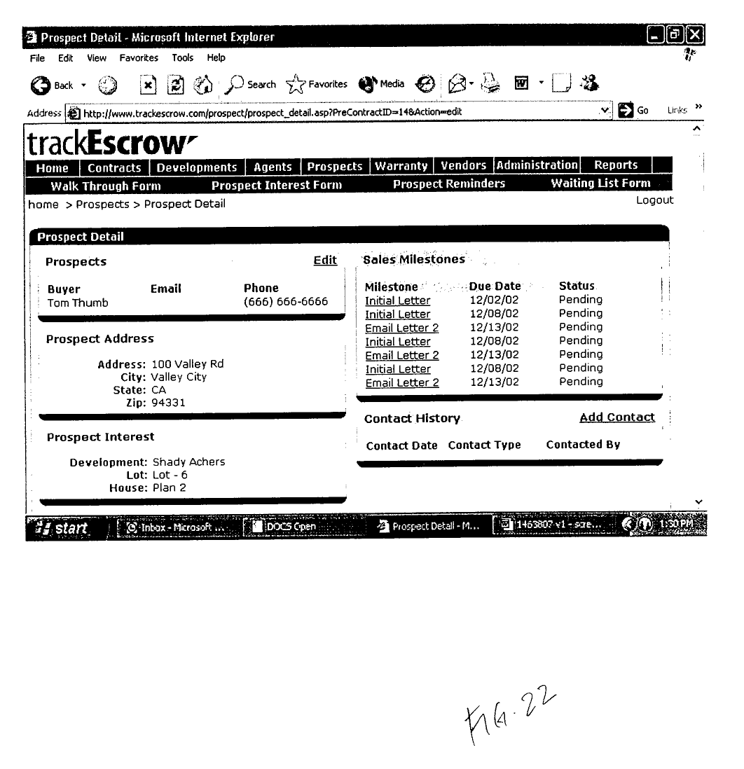

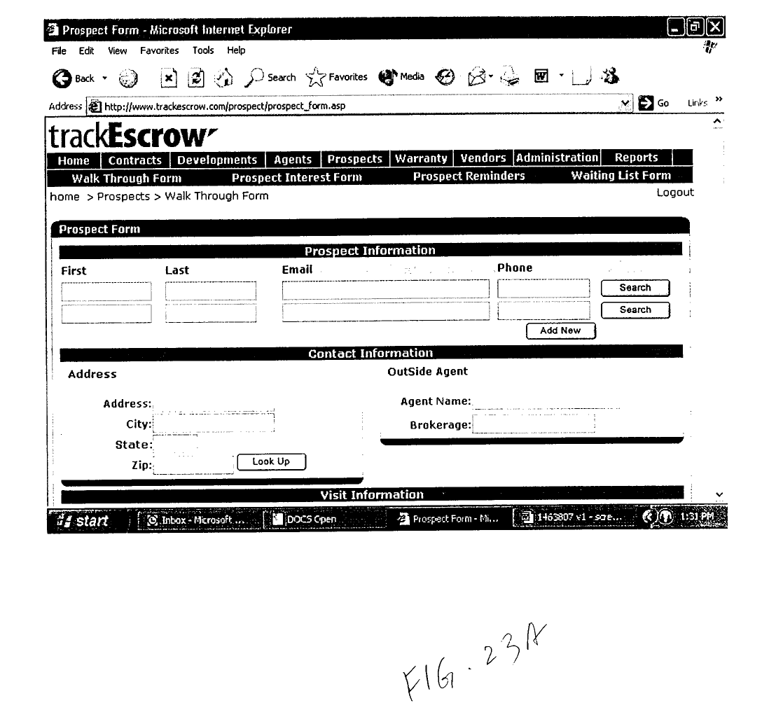

FIGS. 23A and 23B collectively illustrate an exemplary form displayed by the system to allow the general manager to collect information from a prospect during a walk-through. This exemplary form is displayed when the “walk-through form” 362 is selected.

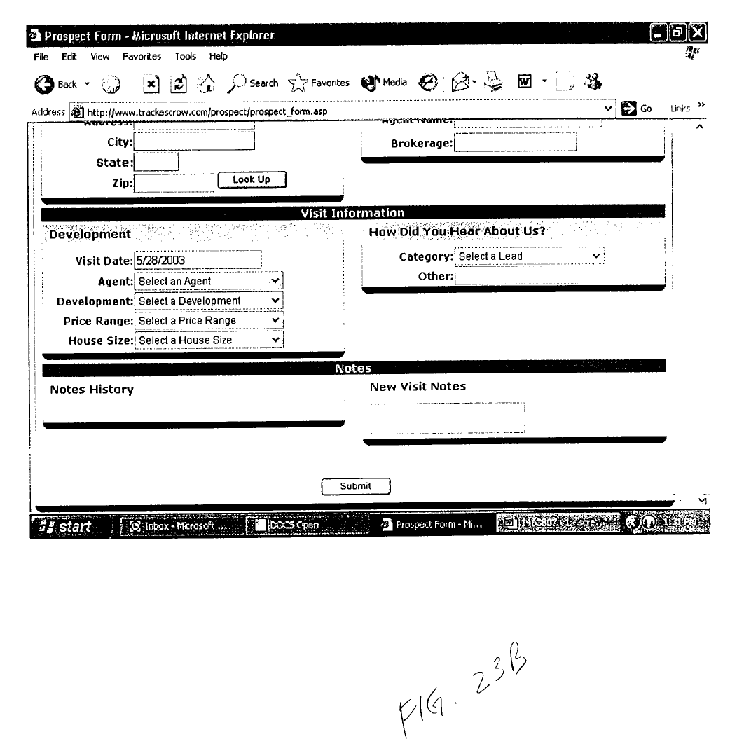

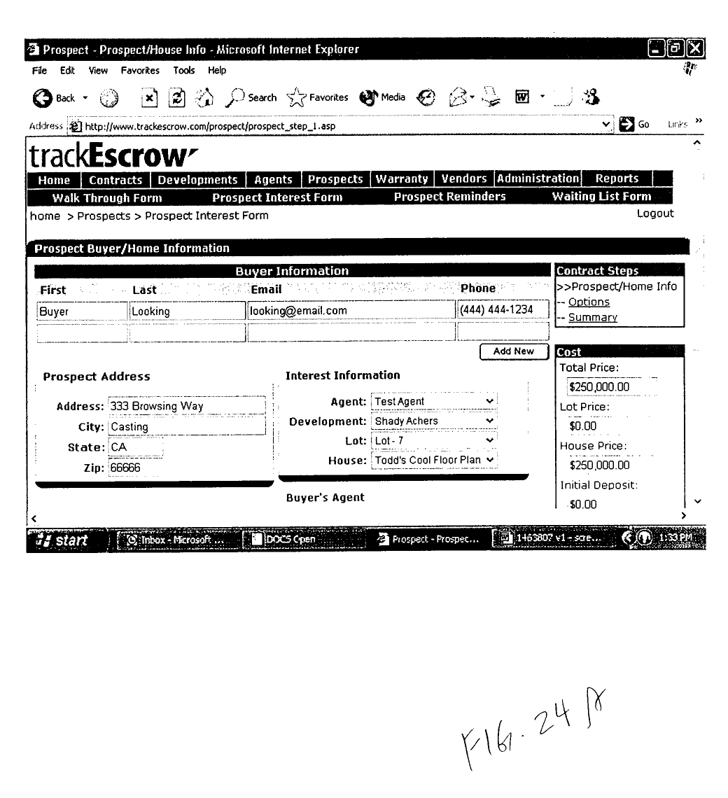

FIGS. 24A and 24B collectively illustrate an exemplary form displayed by the system to allow the general manager to collect information from a prospect when the prospect expresses a more serious interest in making a purchase. This exemplary form is displayed when the “prospect interest form” 358 is selected. For example, as shown in FIG. 24C, the system further provides a form that allows information relating to contract options to be collected from the prospect. FIG. 24D illustrates an exemplary display showing a summary of the information collected from the prospect.

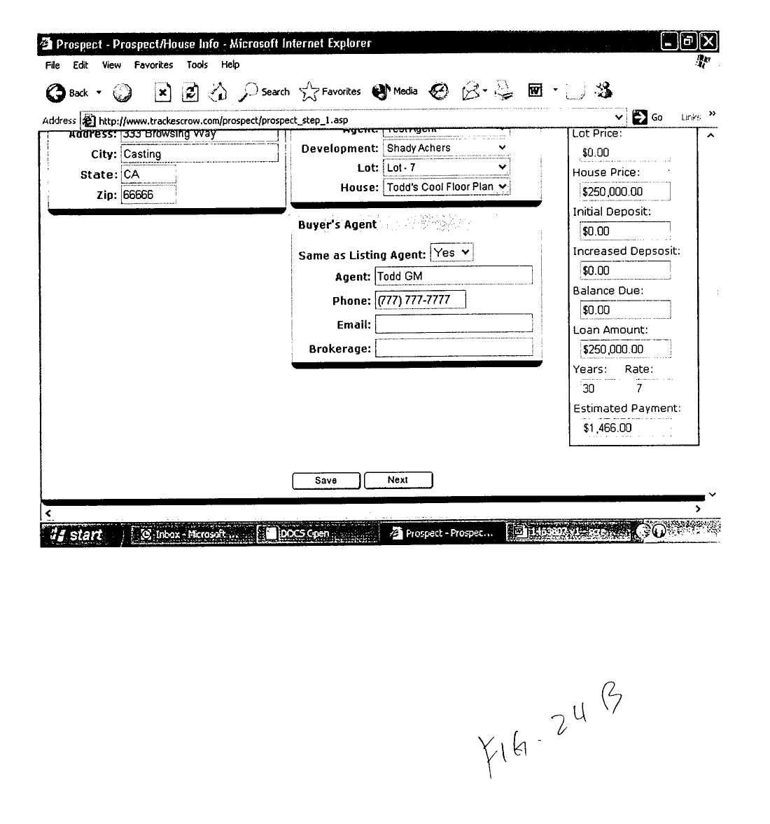

FIG. 25 illustrates another exemplary form displayed by the system to allow the general manager to collect miscellaneous information that can be used to generate reminders.

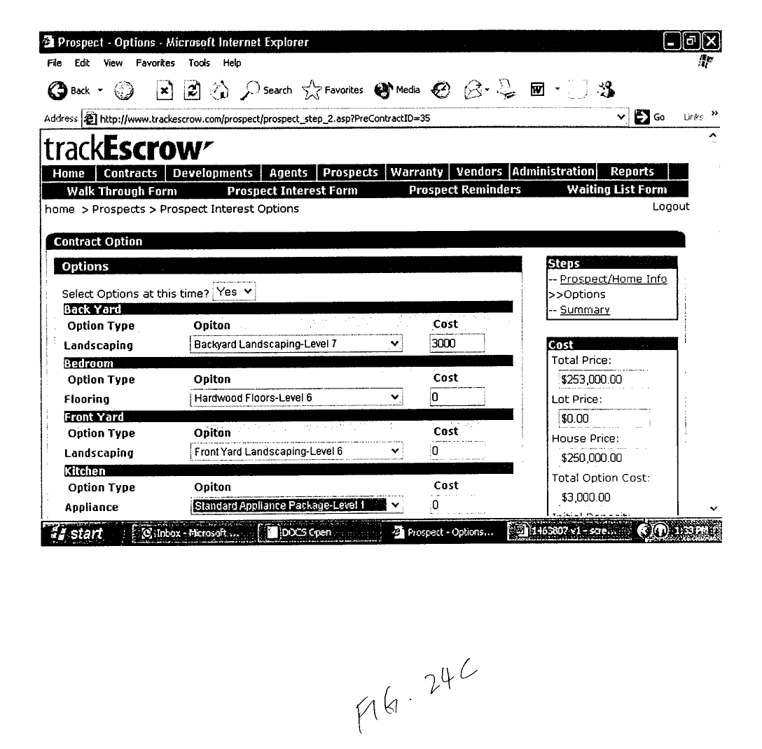

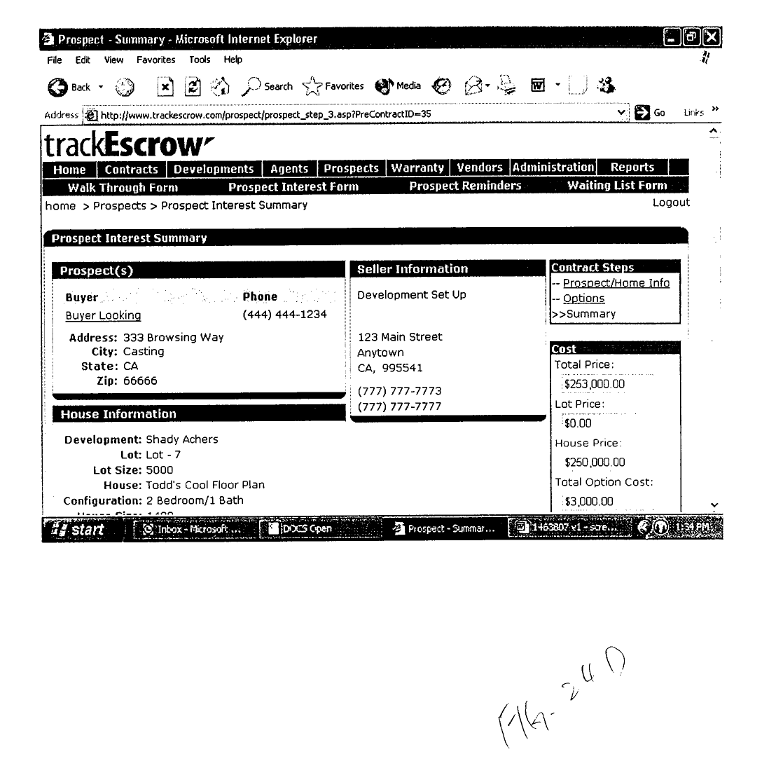

FIG. 26 illustrate an exemplary form displayed by the system to allow the general manager to collect information from a prospect for wait-listing purposes.

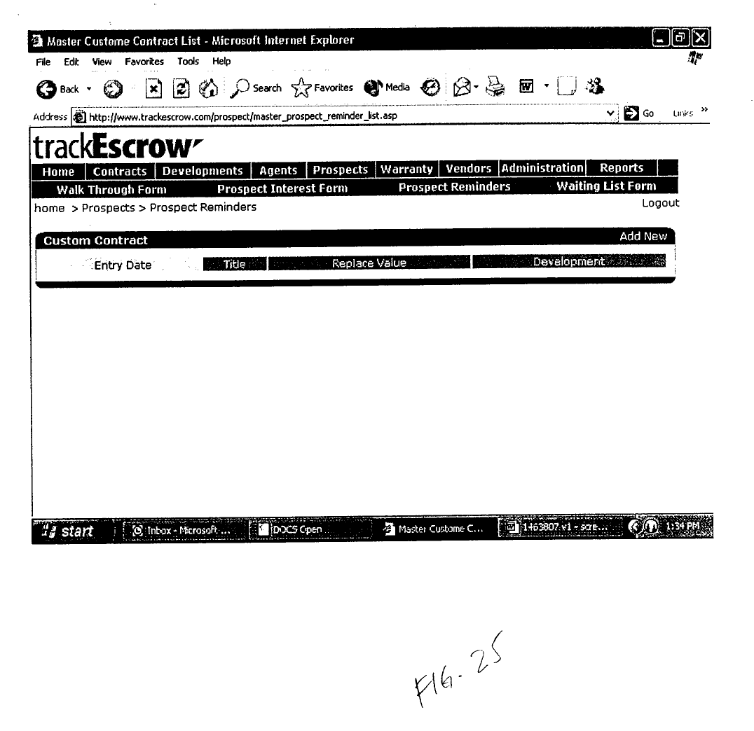

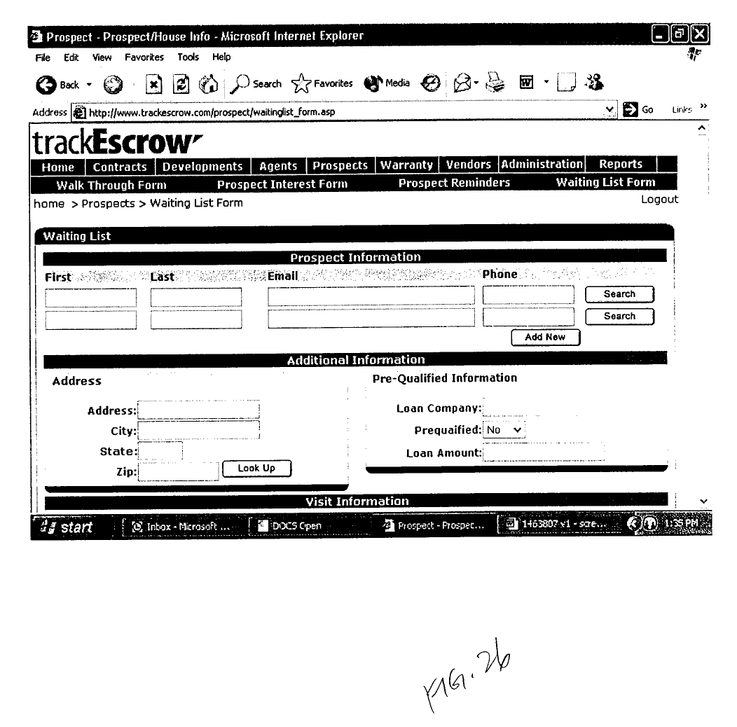

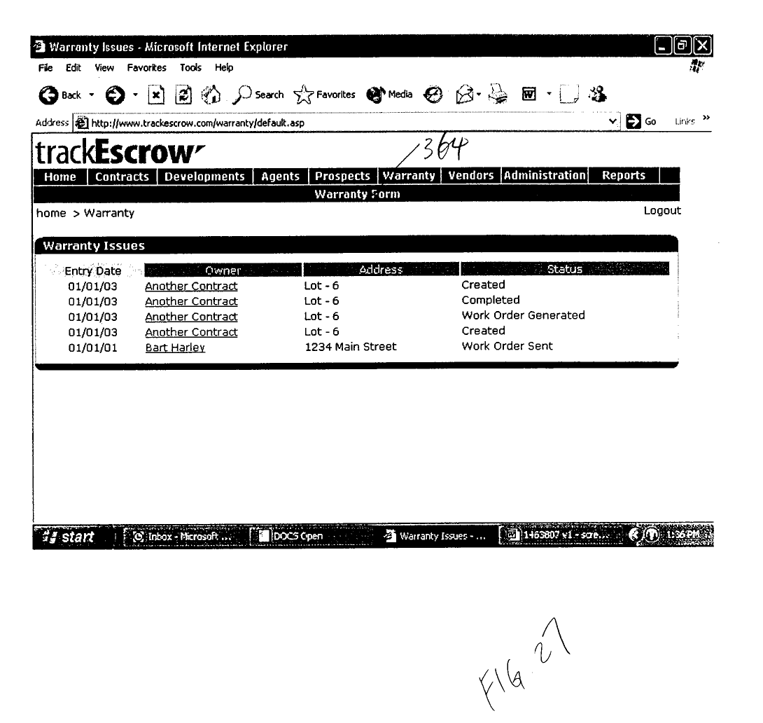

Referring back to FIG. 3, the system allows the general manager to manage warranty issues by clicking on the “warranty” hypertext link 314. FIG. 27 illustrates the functionality offered by the system when the general manager selects the “warranty” hypertext link 314. As shown in FIG. 27, the system displays a list of warranty issues. Information relating to each warranty issue is also displayed including, for example, owner, address and status, etc. Additional information is available for viewing by clicking on the corresponding hypertext links. FIG. 28 shows the information that is displayed when a specific warranty issue is selected. Such information includes, for example, warranty creation information, warranty activity and warranty history, etc. The system further allows information to be modified. For example, the warranty creation information and the warranty activity can be updated and/or added.

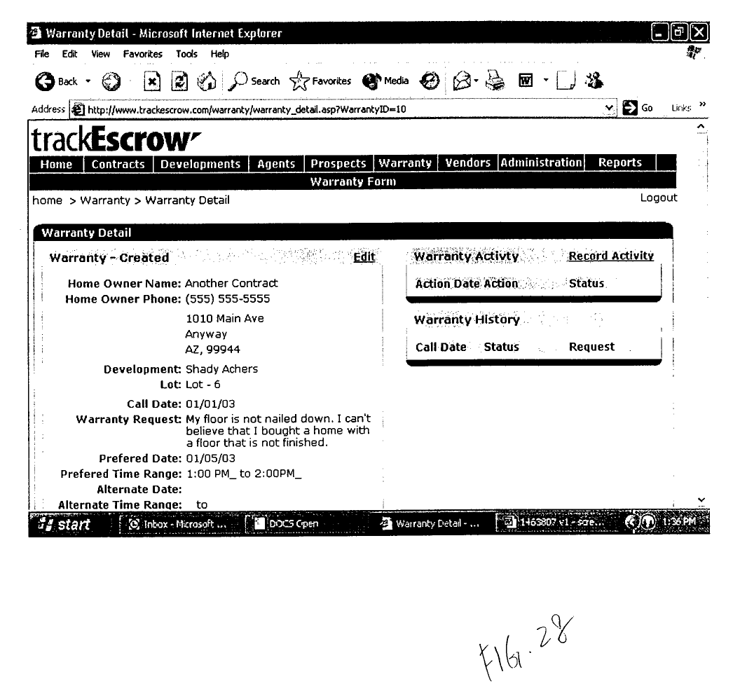

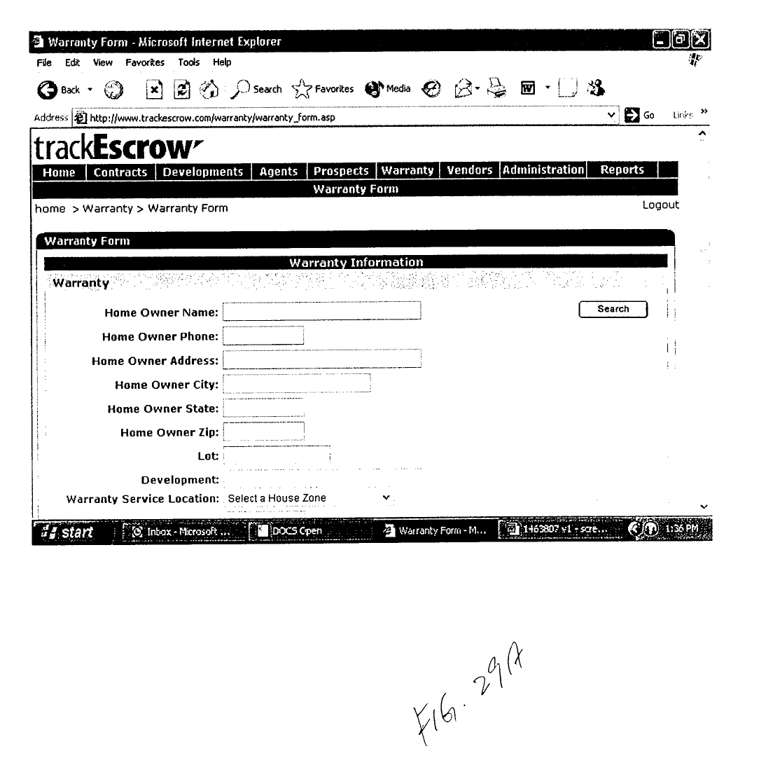

As shown in FIG. 27, the general manager can collect new warranty information by clicking on the “warranty form” hypertext link 364. FIGS. 29A and 29B collectively illustrate an exemplary form displayed by the system when the “warranty form” hypertext link 364 is selected. This form can used by the general manager to collect the appropriate and generate a new warranty issue. Once the information has been collected, the system generates the appropriate milestones for the warranty issue. What types of milestones are generated depends on the warranty issue. Based on the disclosure and teachings provided herein, a person of ordinary skill in the art will appreciate how to generate the appropriate warranty milestones. The system then ensures that the appropriate parties are informed of the newly generated milestones, for example, by including such milestones in the To-Do area 304.

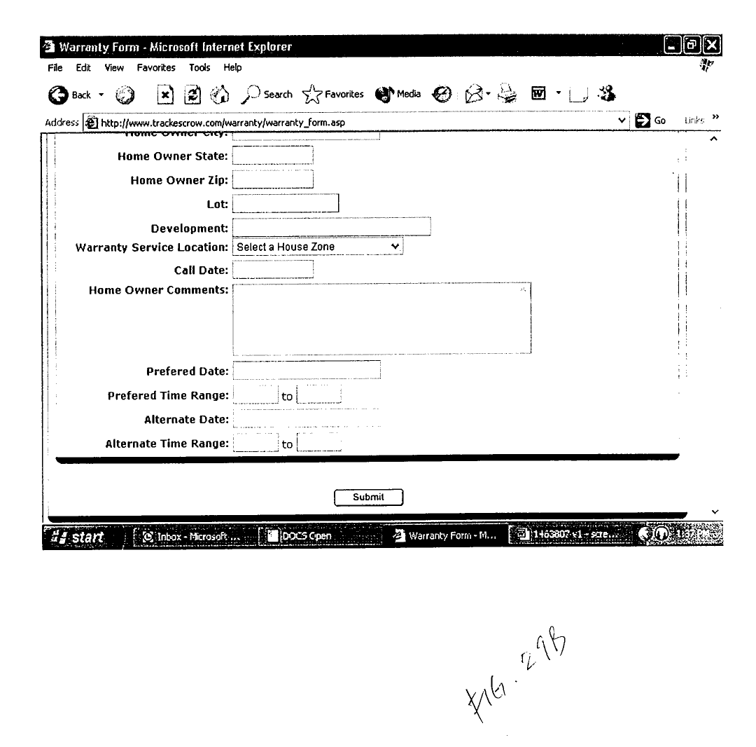

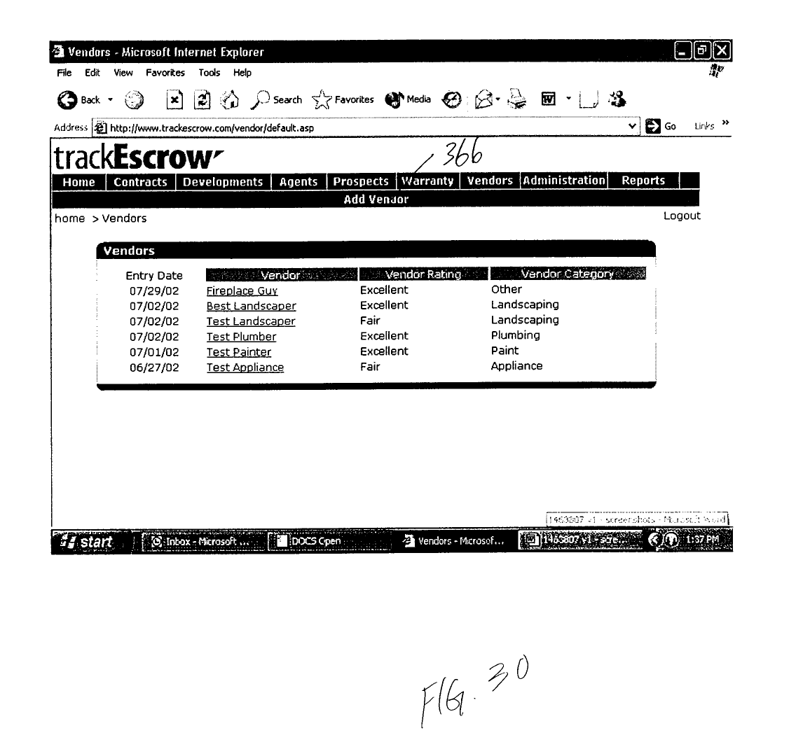

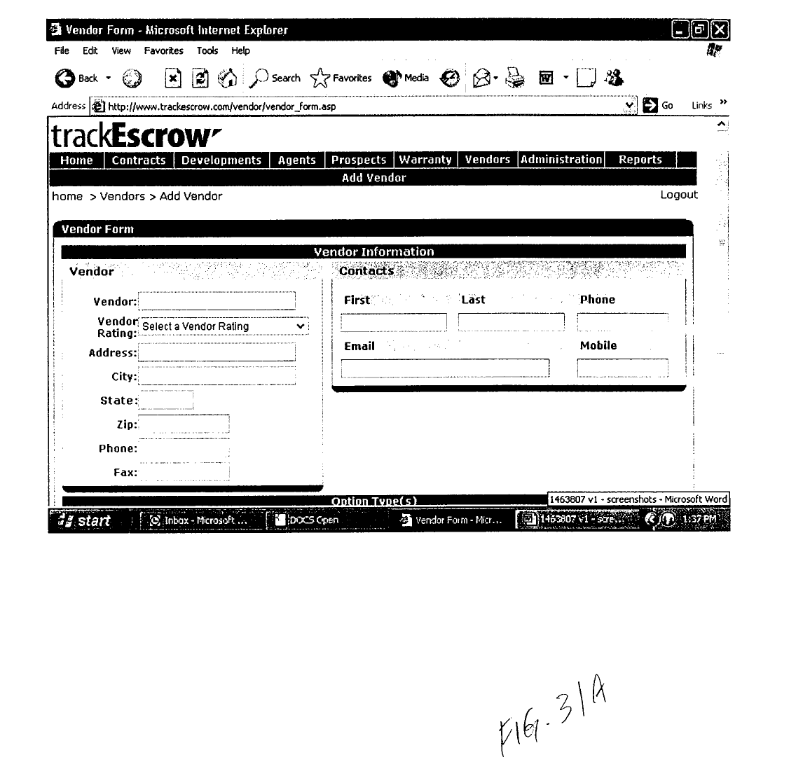

Referring back to FIG. 3, the system allows the general manager to capture information relating to vendors by clicking on the “vendors” hypertext link 316. Vendors are companies that either are responsible for warranties or provide the services to repair the items under warranty. Items in a house can be under warranty offered by different parties. Some items may be under warranty offered by the developer, while other items may be under warranty offered by their respective vendors or manufacturers. The system collects information relating to vendors for warranty purposes thereby allowing any warranty issues to be resolved more efficiently. FIG. 30 displays a list of vendors when the “vendors” hypertext link 316 is selected. Information relating to each vendor is also provided including, for example, vendor name, vendor rating and vendor category, etc. Additional information can be viewed by clicking on the corresponding hypertext link. Furthermore, as shown in FIG. 30, the system allows the general manager to add additional or new vendors by clicking on the “add vendor” hypertext link 366. FIGS. 31A and 31B collectively illustrate an exemplary form displayed by the system to collect information relating to the new vendor. By collecting the vendor information, the system allows warranty issues to be resolved more efficiently and effectively. For example, if an item is under warranty offered by a vendor, the system allows such vendor to be identified and contacted promptly. In another instance, if an item is under warranty offered by the developer and the developer needs a vendor to perform the necessary repair, the system allows the developer to identify the more reputable and reliable vendor(s).

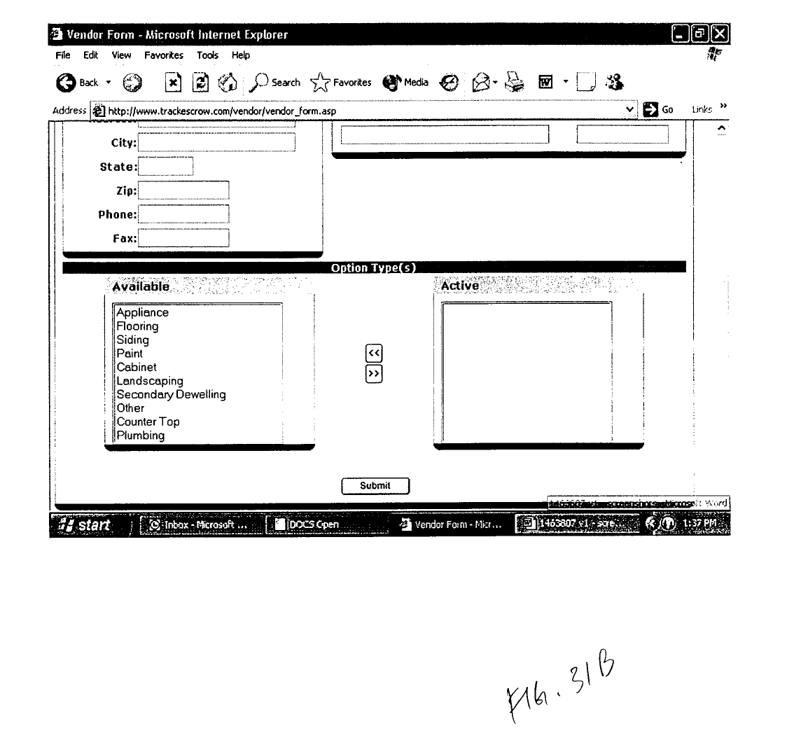

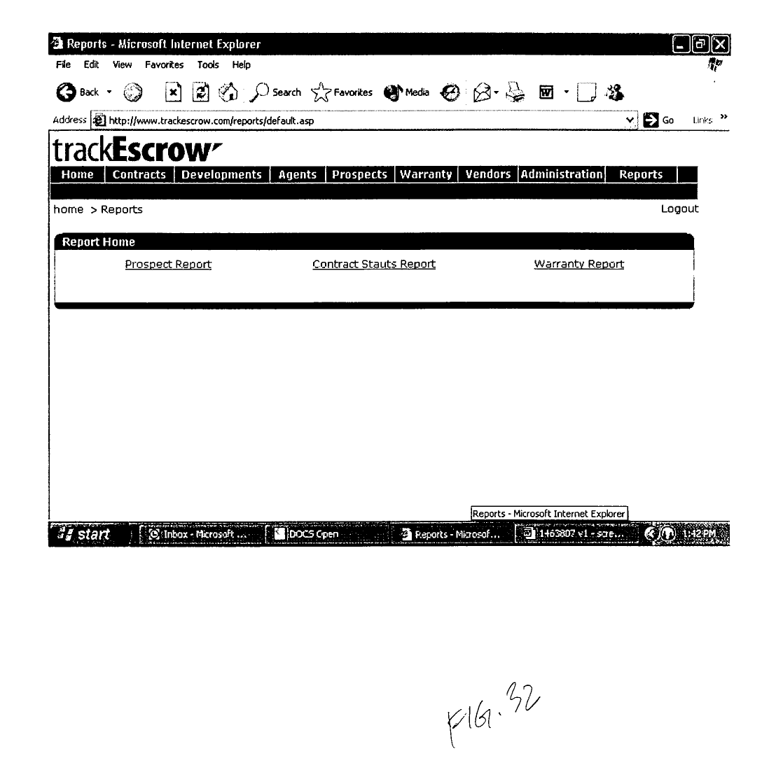

Referring back to FIG. 3, the system allows the general manager to generate different types of reports by clicking on the “reports” hypertext link 320. FIG. 32 illustrates the functionality offered by the system when the “reports” hypertext link 320 is selected. Different types of reports can be generated by the system including, for example, prospect report, contract status report and warranty report, etc. Based on the disclosure and teachings provided herein, a person of ordinary skill in the art will appreciate the types of information that can be included in the reports as well as other types of reports that can be generated in accordance with the present invention.

As mentioned above, the system allows users with different functional roles to access and/or view different types of information and perform different types of functions. Some or all of the functionality of the system described above can be made available to other users with different functional roles.

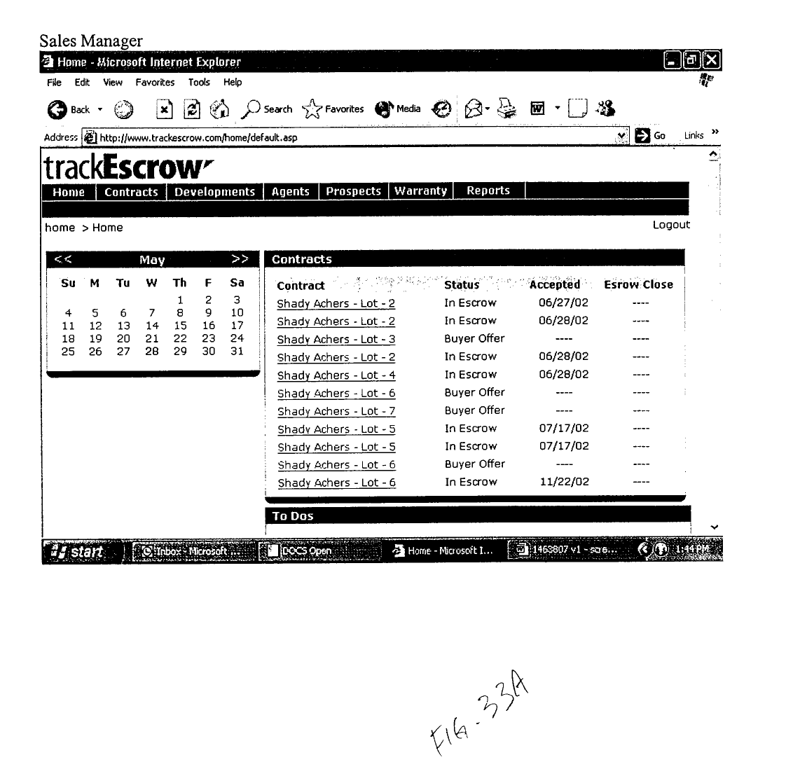

FIGS. 33A and 33B illustrate the functionality offered by the system to a sales manager. Similarly, the system displays a list of contracts and their associated to-do items that s/he is responsible for. Unlike the general manager, the sales manager is given only authority to access and view his/her contracts.

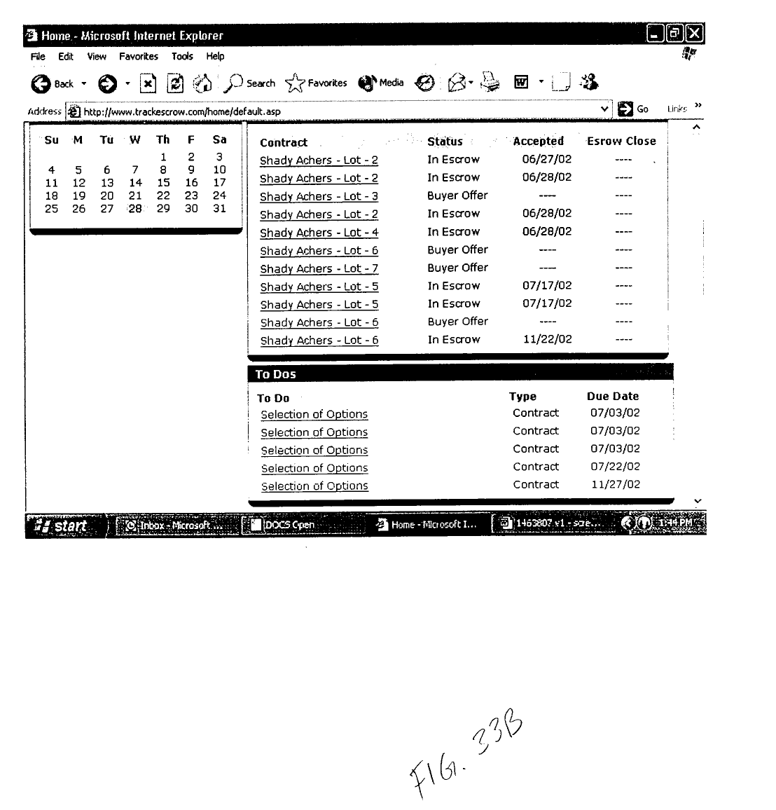

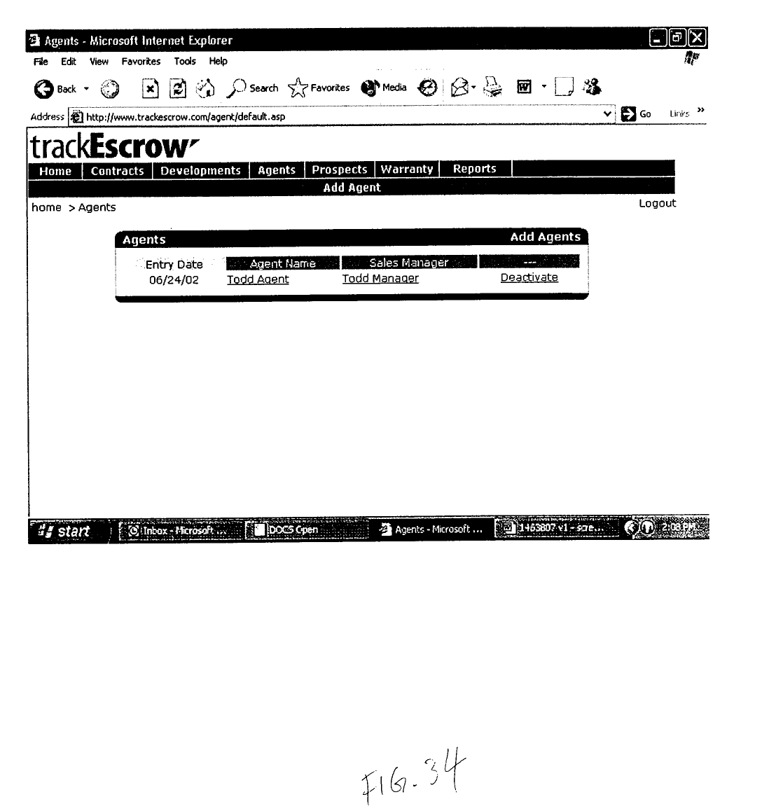

FIG. 34 illustrates the functionality offered by the system to the sales manager to manage his/her agent(s). Similarly, the system displays a list of agent(s) that the sales manager is responsible for and allows the sales manager to add or remove agents. Unlike the general manager, the sales manager is given only authority to manage his/her own agents but not agents of other sales managers.

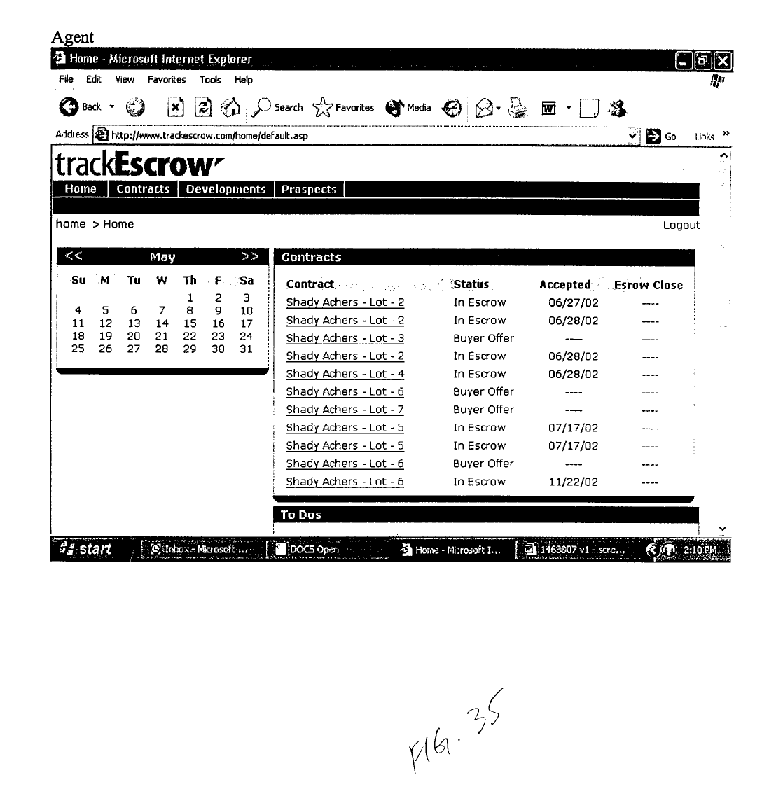

FIG. 35 illustrates the functionality offered by the system to an agent. The system displays a list of contracts and their associated to-do items that the agent is responsible for. However, the agent is not given authority to manage contracts belonging to other agents. Also, the agent is not given authority to manage other agents.

As described above, the system of the present invention offers a number of functionality for managing real estate purchase transactions. In one exemplary aspect, such functionality is made available to users with different functional roles. Based on the disclosure and teachings provided herein, it will be appreciated by a person of ordinary skill in the art that how and what functionality is made available to different functional users depend on the design and/or constraints of each deployment.

Furthermore, it should be understood that the description provided above in connection with the functionality of the system is not intended to be limiting. Depending on other factors that may govern or affect real estate purchase transactions, the functionality described above may be modified or other functionality may be added to the system in accordance with the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for managing a real estate purchase transaction, comprising:
control logic configured to receive information from a buyer;
control logic configured to create a contract using the received information;
control logic configured to generate one or more milestones associated with the contract; and
control logic configured to monitor the one or more milestones associated with the contract to ensure their completion during the real estate purchase transaction.

2. The system of claim 1 wherein the one or more milestones associated with the contract include closing escrow.

3. The system of claim 1 wherein the information received from the buyer includes financial information.

4. The system of claim 1 wherein the information received from the buyer includes options information.

5. The system of claim 1 wherein the information received from the buyer includes information on contingent property.

6. The system of claim 1 further comprising:
control logic configured to allow a seller to make a counter offer to the contract.

7. The system of claim 1 wherein the control logic configured to monitor the one or more milestones associated with the contract further includes:
control logic configured to inform corresponding parties responsible for completion of the one or more milestones associated with the contract.

8. The system of claim 1 further comprising:
control logic configured to manage information from a prospect;
control logic configured to generate one or more milestones associated with the prospect; and
control logic configured to monitor the one or more milestones associated with the prospect to ensure their completion.

9. The system of claim 8 wherein the one or more milestones associated with the prospect include following up with the prospect.

10. The system of claim 8 wherein the control logic configured to monitor the one or more milestones associated with the prospect further includes:
control logic configured to inform corresponding parties responsible for completion of the one or more milestones associated with the prospect.

11. The system of claim 1 further comprising:
control logic configured to manage information relating to a warranty issue arising out of the contract;
control logic configured to generate one or more milestones associated with the warranty issue; and
control logic configured to monitor the one or more milestones associated with the warranty issue to ensure their completion.

12. The system of claim 11 further comprising:
control logic configured to manage information relating to a vendor; and
control logic configured to make the information relating to the vendor available in order to help resolve the warranty issue.

13. The system of claim 12 wherein the information relating to the vendor includes vendor rating.

14. The system of claim 12 wherein the vendor is responsible for providing a warranty in connection with the warranty issue.

15. The system of claim 11 wherein the control logic configured to monitor the one or more milestones associated with the warranty issue further includes:
control logic configured to inform corresponding parties responsible for completion of the one or more milestones associated with the warranty issue.

16. The system of claim 1 wherein the system is implemented using computer software.

17. A system for managing real estate purchase transactions, comprising:
control logic configured to receive information from a plurality of buyers;
control logic configured to create a plurality of contracts using the received information;
control logic configured to generate one or more milestones for each of the plurality of contracts; and
control logic configured to monitor the one or more milestones for each of the plurality of contracts to ensure their completion.

18. The system of claim 17 wherein the one or more milestones for at least one of the plurality of contracts include closing escrow.

19. The system of claim 17 wherein the information received from at least one of the plurality of buyers includes financial information.

20. The system of claim 17 wherein the information received from at least one of the plurality of buyers includes options information.

21. The system of claim 17 wherein the information received from at least one of the plurality of buyers includes information on contingent property.

22. The system of claim 17 further comprising:
control logic configured to allow a seller to make a counter offer to at least one of the plurality of contracts.

23. The system of claim 17 wherein the control logic configured to monitor the one or more milestones for each of the plurality of contracts further includes:
control logic configured to inform corresponding parties responsible for completion of the one or more milestones for each of the plurality of contracts.

24. The system of claim 17 further comprising:
control logic configured to manage information from a plurality of prospects;
control logic configured to generate one or more milestones for each of the plurality of prospects; and
control logic configured to monitor the one or more milestones for each of the plurality of prospects to ensure their completion.

25. The system of claim 24 wherein the one or more milestones for each of the plurality of prospects include following up with the plurality of prospects.

26. The system of claim 24 wherein the control logic configured to monitor the one or more milestones for each of the plurality of prospects further includes:
control logic configured to inform corresponding parties responsible for completion of the one or more milestones for each of the plurality of prospects.

27. The system of claim 17 further comprising:
control logic configured to manage information relating to one or more warranty issues arising out of one or more of the plurality of contracts;
control logic configured to generate one or more milestones for each of the one or more warranty issues; and
control logic configured to monitor the one or more milestones for each of the one or more warranty issues to ensure their completion.

28. The system of claim 27 further comprising:
control logic configured to manage information relating to one or more vendors; and
control logic configured to make the information relating to the one or more vendors available in order to help resolve the one or more warranty issues.

29. The system of claim 28 wherein the information relating to the one or more vendors includes vendor rating.

30. The system of claim 28 wherein at least one of the one or more vendors is responsible for providing a warranty in connection with the one or more warranty issues.

31. The system of claim 27 wherein the control logic configured to monitor the one or more milestones for each of the one or more warranty issues further includes:
control logic configured to inform corresponding parties responsible for completion of the one or more milestones for each of the one or more warranty issues.

32. The system of claim 17 wherein the system is implemented using computer software.

33. The system of claim 17 further comprising:
control logic configured to manage information relating to a plurality of developments.

34. The system of claim 33 wherein the information relating to the plurality of developments includes a list of options.

35. The system of claim 33 wherein the information relating to the plurality of developments includes a list of option types.

36. The system of claim 33 wherein the information relating to the plurality of developments includes information relating to one or more agents assigned to handle each of the plurality of developments.

37. The system of claim 17, wherein the plurality of contracts are respectively managed by a plurality of agents, further comprising:
control logic configured to display information relating to a first agent from the plurality of agents.

38. The system of claim 37 wherein the displayed information includes contracts being managed by the first agent.

39. The system of claim 37 wherein the displayed information includes the one or more milestones for each of the contracts being managed by the first agent.

40. The system of claim 17 further comprising:
control logic configured to assign an agent to one or more developments.

41. The system of claim 17 further comprising:
control logic configured to assign a sales manager to one or more agents.
